(19) United States
(12) Patent Application Publication
(10) Pub. No.: US 2011/0188076 A1
(43) Pub. Date: Aug. 4, 2011

(54) IMAGE DISPLAY DEVICE

(75) Inventor: Tetsuya Maeda, Osaka-shi (JP)

(73) Assignee: KYOCERA MITA CORPORATION, Osaka-shi (JP)

(21) Appl. No.: 13/011,049

(22) Filed: Jan. 21, 2011

(30) Foreign Application Priority Data
Jan. 29, 2010 (JP) 2010-017764
Feb. 16, 2010 (JP) 2010-031685
Feb. 16, 2010 (JP) 2010-031686

(51) Int. Cl. G06F 15/00

(52) U.S. Cl. 358/1.15

(57) ABSTRACT

A complex machine is provided with a communication unit such as a facsimile communication unit, a communication destination storage that stores a plurality of pieces of communication destination information for communication destinations to be communicated with by the communication unit, a display unit, a display controller that controls the display of the display unit, a communication destination receiving section that receive the communication destination, with which communication is to be carried out by the communication unit, together with the communication destination information from an operator, and a selection criterion storage that stores a selection criterion used to select the communication destinations and communication destination information to be displayed on the display unit. The display controller extracts the communication destination information according to the selection criterion and causes the display unit to display the extracted communication destination information.

### BACKGROUND OF THE INVENTION

1. Field of the Invention

The present invention relates to an image display device and particularly to a technology for causing a display unit to display a communication method and communication destination specific information used for this communication method stored for each communication destination at the time of facsimile, electronic mail or other communication.

2. Description of the Related Art

Conventionally, there have been known communication apparatuses for facsimile, electronic mail or other communication with a communication destination designated by an operator. In such a communication apparatus, a plurality of communication methods and communication destination specific information used for these communication methods such as a facsimile number, a mail address and an IP address can be so stored as to belong to one communication destination registered in the apparatus for facsimile communication, electronic mail communication, scanned data transmission to network-connected personal computers and other communication.

### SUMMARY OF THE INVENTION

The present invention is a further improvement of the above prior art.

Specifically, the present invention is directed to an image display device, comprising, a communication unit that carries out communication; a communication destination storage capable of storing a plurality of pieces of communication destination information, each of which is a combination of a communication method and communication destination specific information used for this communication method, for each communication destination to be communicated with by the communication unit; a display unit that displays the communication destinations and communication destination information; a display controller that causes the display unit to display the communication destination information for each communication destination stored in the communication destination storage; a communication destination receiving section that receives the communication destination, with which communication is carried out by the communication unit, together with the communication destination information from an operator when pieces of communication destination information for the communication destinations are displayed on the display unit by the display controller; and a selection criterion storage that stores a selection criterion used to select the communication destinations and their corresponding pieces of communication destination information stored in the communication destination storage as items to be displayed on the display unit; wherein the display controller extracts the communication destination and communication destination information from the communication destination storage according to the selection criterion stored in the selection criterion storage and causes the display unit to display the extracted communication destination information and communication destination specific information when causing the display unit to display the communication destinations and their corresponding pieces of communication destination information. These and other objects, features and advantages of the present invention will become more apparent upon reading the following detailed description along with the accompanying drawings.

### BRIEF DESCRIPTION OF THE DRAWINGS

FIG. 1 is a schematic side view showing a construction of a complex machine as an example of an image forming apparatus according to one embodiment of the invention.

FIG. 2 is a partial enlarged view of an operation unit.

FIG. 3 is a control block diagram of the complex machine shown in FIG. 1.

FIG. 4 is a flow chart showing a process performed upon setting display priority of communication destination information for a communication destination in the complex machine.

FIG. 5 is a diagram showing an exemplary display screen of a display unit.

FIG. 6 is a diagram showing an exemplary display screen of the display unit.

FIG. 7 is a diagram showing an exemplary display screen of the display unit.

FIG. 8 is a diagram showing an exemplary display screen of the display unit.

FIG. 9 is a flow chart showing a first embodiment of a process of displaying communication destinations and communication destination information by the complex machine.

FIG. 10 is a diagram showing an exemplary display screen of the display unit.

FIG. 11 is a diagram showing an exemplary display screen of the display unit.

FIG. 12 is a flow chart showing a second embodiment of the process of displaying the communication destinations and communication destination information by the complex machine.

FIG. 13 is a flow chart showing a third embodiment of the process of displaying the communication destinations and communication destination information by the complex machine.

FIG. 14 is a diagram showing an exemplary display screen of the display unit.

FIG. 15 is a diagram showing an exemplary display screen of the display unit.

FIG. 16 is a control block diagram of a complex machine for performing a process according to a fifth embodiment.

FIG. 17 is a flow chart showing a process upon setting a communication destination and extraction information used to extract a communication destination information used for the setting of the communication destination in the complex machine.

FIG. 18 is a diagram showing an exemplary display screen of the display unit.

FIG. 19 is a diagram showing an exemplary display screen of the display unit.

FIG. 20 is a diagram showing an exemplary display screen of the display unit.

FIG. 21 is a flow chart showing a fifth embodiment of the process of displaying the communication destinations and communication destination information by the complex machine.

FIG. 22 is a diagram showing an exemplary display screen of the display unit.

FIG. 23 is a diagram showing an exemplary display screen of the display unit.

FIG. 24 is a flow chart showing a first modification of the fifth embodiment of the process at the time of displaying the communication destination and the communication destination information by the complex machine.

FIG. 25 is a flow chart showing a second modification of the fifth embodiment of the process at the time of displaying the communication destination and the communication destination information by the complex machine.

FIG. 26 is a diagram showing an exemplary display screen of the display unit.

FIG. 27 is a diagram showing an exemplary display screen of the display unit.

FIG. 28 is a flow chart showing a fourth embodiment of the process of displaying the communication destinations and communication destination information by the complex machine.

FIG. 29 is a diagram showing an exemplary display screen of the display unit.

FIG. 30 is a flow chart showing a third modification of the fifth embodiment of the process at the time of displaying the communication destination and the communication destination information by the complex machine.

FIG. 31 is a diagram showing an exemplary display screen of the display unit.

FIG. 32 is a diagram showing an exemplary display screen of the display unit.

FIG. 33 is a diagram showing an exemplary display screen of the display unit.

FIG. 34 is a control block diagram of a complex machine for performing a process according to a sixth embodiment.

FIG. 35 is a flow chart showing a first example of an sixth embodiment of a process of displaying a communication destination and a communication result on the display unit.

FIG. 36 is a diagram showing an exemplary display screen of the display unit.

FIG. 37 is a flow chart showing a second example of an sixth of the process of displaying the communication destinations and communication destination information by the complex machine.

FIG. 38 is a diagram showing an exemplary display screen of the display unit.

FIG. 39 is a flow chart showing another modification.

FIGS. 40A and 40B are diagrams exemplary display screens of the display unit.

### DETAILED DESCRIPTION OF THE PREFERRED EMBODIMENTS

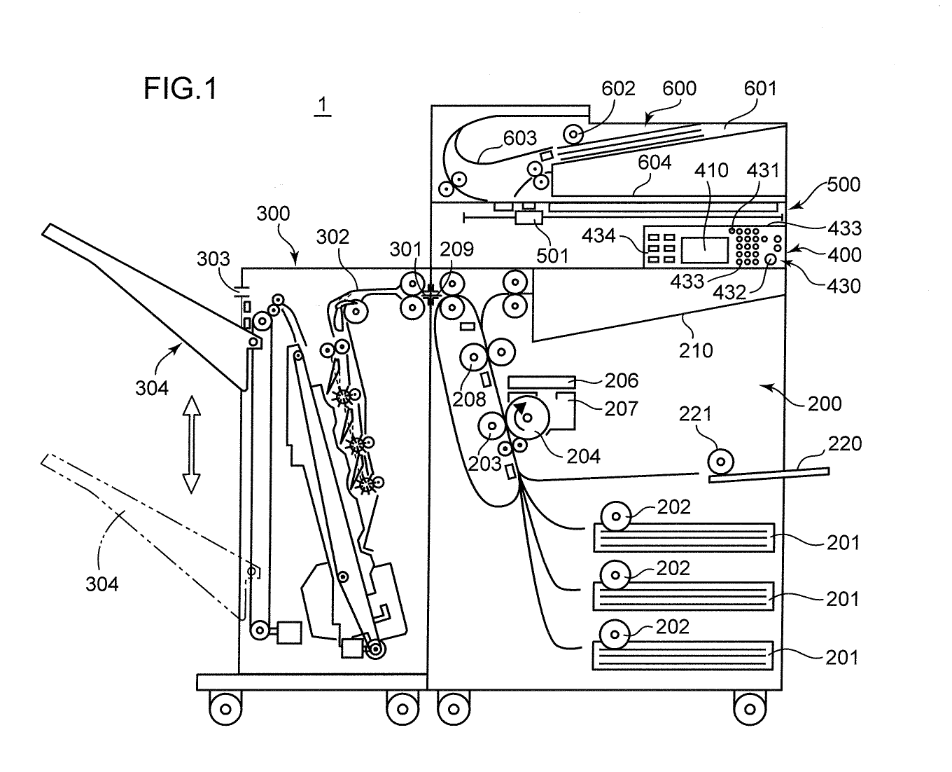

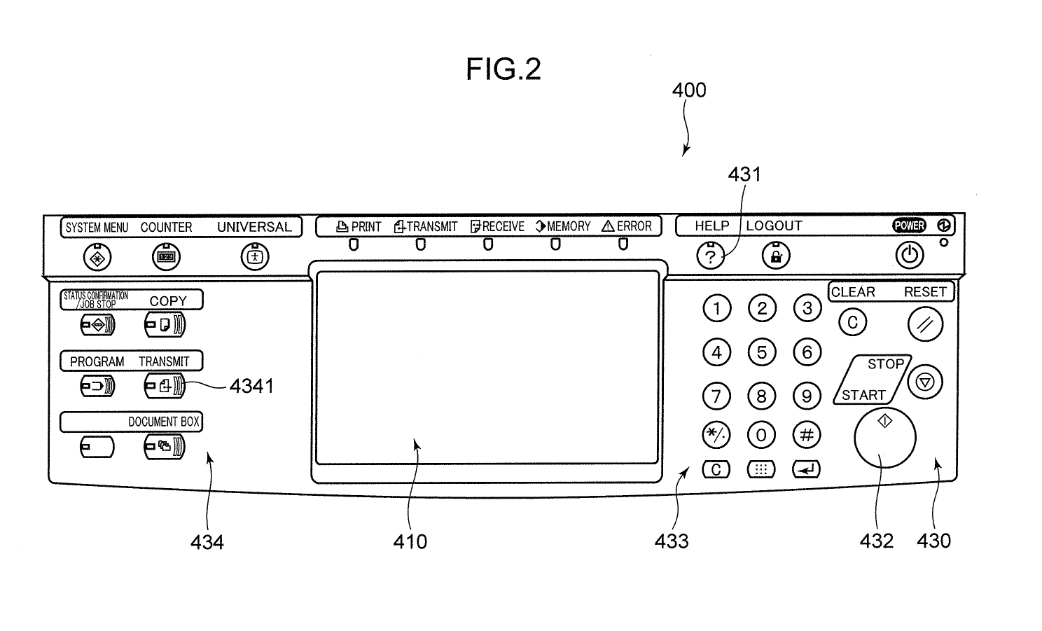

Hereinafter, an image display device and an image forming apparatus according to one embodiment of the present invention are described with reference to the drawings. FIG. 1 is a schematic side view showing a construction of a complex machine as an example of the image forming apparatus according to one embodiment of the present invention. FIG. 2 is a partial enlarged view of an operation unit 400. Hereinafter, a process by an image display device according to the embodiment of the present invention is described as a process of the complex machine 1 including the image display device.

The complex machine 1 has scanner function, facsimile function, printer function, copy function and other functions. The complex machine 1 is provided with a main unit 200, a sheet post-processing unit 300 arranged on a sheet carry-out side, i.e. on the left side of the main unit 200, the operation unit 400 used by an operator to enter various operation instructions and the like, a document reading unit 500 arranged on the main unit 200 and a document feeding unit 600 arranged on the document reading unit 500.

As also shown in FIG. 2, the operation unit 400 includes a display unit 410 composed of an LCD (Liquid Crystal Display) and the like, and an operation key unit 430 used by an operator to enter operation instructions. The operation key unit 430 includes a help key 431, a start key 432, a numerical pad 433 and function changeover keys 434.

The help key 431 receives instructions from the operator to cause the display unit 410 to display operation screens (help screens) for displaying respective operation methods on the scanner function, facsimile function, printer function, copy function and other functions.

The start key 432 receives instructions from the operator to start respective operations such as a copying operation and a scanning operation. The numerical pad 433 includes keys for receiving instructions designating the number of copies and the like from the operator. In this embodiment, the numerical pad 433 functions as an information input section for receiving input of information (e.g. user box number) necessary to enter an operation instruction corresponding to an operation screen being displayed on the display unit 410.

The function changeover keys 434 are keys for receiving instructions from the operator to switch the function among the copy function, transmit function (scanner function, facsimile function, etc.) and document box function (function of reading and printing data stored in a storage area (mail boxes) in an HDD 74 to be described later).

The display unit 410 includes a touch panel unit composed of the LCD (Liquid Crystal Display) and the like and having a touch panel function. The display unit 410 can display various operation screens and enables the operator to enter execution commands of various functions by touching a display surface (displayed operation keys).

The document feeding unit 600 includes a document placing portion 601, a feed roller 602, a document conveying unit 603 and a document discharging portion 604. The document reading unit 500 includes a scanner 501. The feed roller 602 feeds documents set on the document placing portion 601 one by one, and the document conveying unit 603 successively conveys the fed documents to a reading position of the scanner 501. The scanner 501 successively reads images of the documents being conveyed, and the documents having the images thereof read are discharged onto the document discharging portion 604.

The main unit 200 includes a plurality of sheet cassettes 201, a plurality of pickup rollers 202, a transfer roller 203, a photoconductive drum 204, an exposure device 206, a developing device 207, a fixing roller 208, a discharge port 209, a discharge tray 210 and the like.

The photoconductive drum 204 is uniformly charged by a charger (not shown) while being rotated in an arrow direction. The exposure device 206 scans a laser beam modulated in accordance with an image of a document read by the document reading unit 500 across the photoconductive drum 204 to form electrostatic latent images on a drum surface. The developing device 207 supplies black developer to the photoconductive drum 204 to form a toner image.

On the other hand, the pickup roller 202 picks up a print sheet from the sheet cassette 201 containing print sheets and feeds it to the transfer roller 203. The transfer roller 203 transfers the toner image on the photoconductive drum 204 to the conveyed print sheet, and the fixing roller 208 fixes the transferred toner image to the print sheet by applying heat. Thereafter, the print sheet is carried into the sheet post-processing unit 300 through the discharge port 209 of the main unit 200. Further, the print sheet may be discharged to the discharge tray 210 according to need.

The sheet post-processing unit 300 includes a carry-in port 301, a print sheet conveying unit 302, a carry-out port 305, a stack tray 304, etc. The print sheet conveying unit 302 successively conveys print sheets brought to the carry-in port 301 through the discharge port 209 and finally discharges the print sheets to the stack tray 304 through the carry-out port 303. The stack tray 304 is so constructed as to be vertically movable in arrow directions according to the number of print sheets carried out through the carry-out port 303.

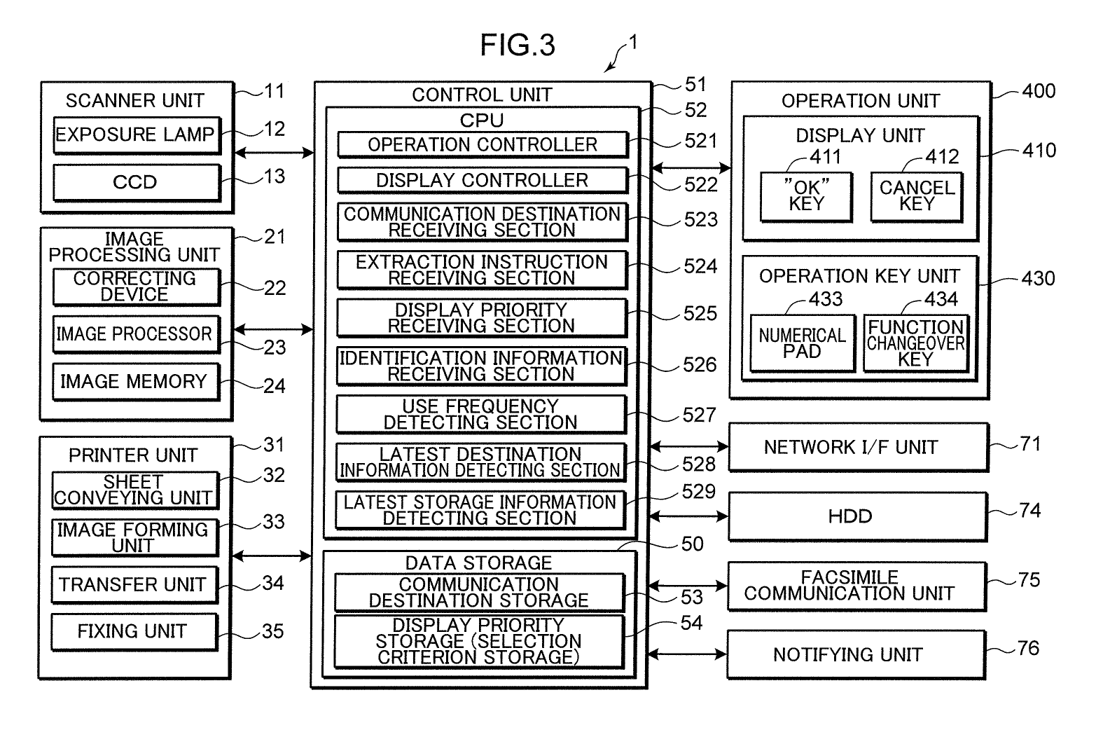

FIG. 3 is a control block diagram of the complex machine 1 shown in FIG. 1. The complex machine 1 is provided with a scanner unit 11, an image processing unit 21, a printer unit 31, the operation unit 400, a control unit 51, a network I/F (interface) unit 71, the HDD (Hard Disk Drive) 74, a facsimile communication unit 75 and a notifying unit 76.

The scanner unit 11 includes an exposure lamp 12 and a CCD (Charge Coupled Device) 13 constituting the scanner 501 shown in FIG. 1. The scanner unit 11 irradiates a document by the exposure lamp 12 and receives reflected light by the CCD 13 to read an image from the document, and outputs an image corresponding to the read image to the image processing unit 21.

The image processing unit 21 includes a correcting device 22, an image processor 23 and an image memory 24. The image processing unit 21 processes a read image by the correcting device 22 and the image processor 23 according to need. The image processed by the image processing unit 21 is stored in the image memory for printing or output to the printer unit 31. The correcting device 22 applies specified correction processings such as a level correction and a γ correction to the read image. The image processor 23 applies various processings such as compression/expansion and size enlargement/reduction to the image.

The printer unit 31 includes a sheet conveying unit 32 composed of the sheet cassettes 201 and the pickup rollers 202 shown in FIG. 1, an image forming unit 33 composed of the photoconductive drum 204, the exposure device 206 and the developing device 207 shown in FIG. 1, a transfer unit 34 composed of the transfer roller 203 shown in FIG. 1 and a fixing unit 35 composed of the fixing roller 208 shown in FIG. 1. The printer unit 31 prints an image on a recording sheet using document data read by the scanner unit 11. Specifically, the sheet conveying unit 32 conveys a recording sheet to the image forming unit 33, the image forming unit 33 forms a toner image corresponding to the above image, the transfer unit 34 transfers the toner image to the recording sheet and the fixing unit 35 fixes the toner image to the recording sheet, whereby an image is formed.

The network I/F unit 71 controls transmission and reception of various data to and from external apparatuses via a LAN or Internet using a router by means of a network interface (10/100 Base-TX) or the like. The network I/F unit 71 transmits document image data read by the scanner unit 11 to a personal computer connected to the complex machine 1, for example, via the LAN and having an address designated by an operator through the operation of the operation unit 400 under the control of an operation controller 521 to store this data in a folder of the personal computer designated by the operator. Further, the network I/F unit 71 transmits an electronic mail via Internet or the like using the router to a computer connected to the complex machine 1 and having an address designated by the operator through the operation of the operation unit 400 under the control of the operation controller 521.

The HDD 74 stores images read by the scanner unit 11 and output formats and the like set for these images.

The operation unit 400 includes the display unit 410 and the operation key unit 430 as shown in FIGS. 1 and 2. The display unit 410 displays a plurality of keys for receiving input of various instructions by the touch panel function under the control of a display controller 522.

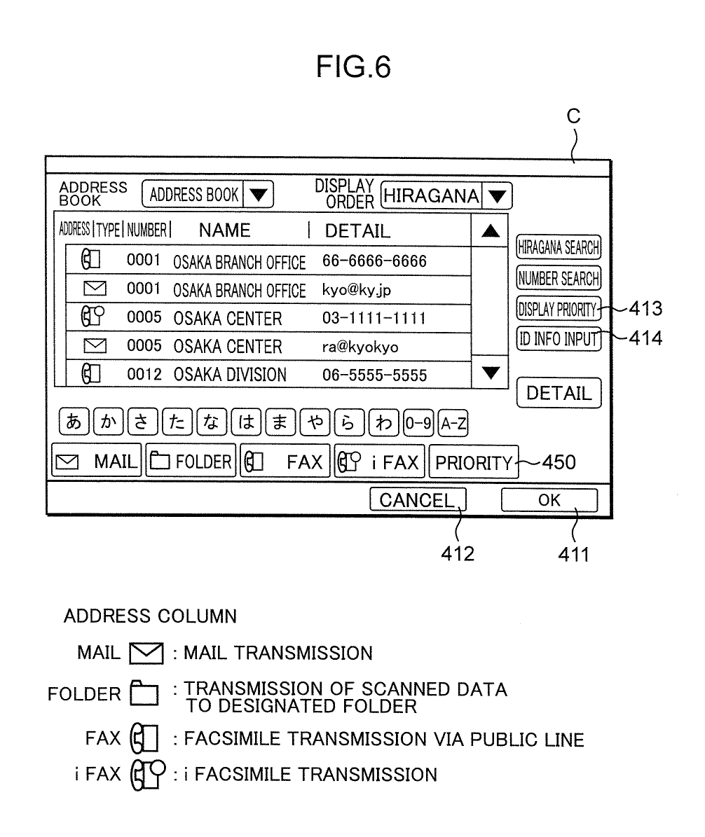

For example, an “OK” key 411 and a cancel key 412 are displayed on the display unit 410 by a display control of the display controller 522 at the time of displaying an address book screen C shown in FIG. 6 to be described later.

The “OK” key 411 is a key for receiving input of an input completion instruction indicating the completion of the input of an operation instruction corresponding to the address book screen C from the operator by the touch panel function.

The cancel key 412 is a soft key for receiving an instruction to cancel the input of the already entered operation instruction from the operator by the touch panel function when the operation instruction corresponding to the address book screen C is already input by the operator.

The operation key unit 430 includes the function changeover keys 434, the start key 432, the numerical pad 433 and the like shown in FIG. 2. A CPU 52 of the control unit 51 receives instructions input by the operator from the respective keys of the display unit 410 and the operation unit 400.

The facsimile communication unit 75 includes an encoder/decoder (not shown), a modulator/demodulator (not shown) and an NCU (Network Control Unit) (not shown). The facsimile communication unit 75 transmits document image data read by the scanner unit 11 to a facsimile machine of a communication destination designated by the operator through the operation of the operation unit 400 via a telephone line and receives image data transmitted from a facsimile machine or the like under the control of the operation controller 521. The encoder/decoder compresses and encodes image data to be transmitted and expands and decodes received image data. The modulator/demodulator modulates the compressed and encoded image data into a sound signal and demodulates a received signal (sound signal) into image data. The NCU controls connection with facsimile machines and the like as transmission and reception destinations by the telephone line. The facsimile communication unit 75 carries out data communication by Internet fax (i facsimile communication) to and from a facsimile machine of a communication destination designated by the operator through the operation of the operation unit 400 or an external facsimile machine which designates the complex machine 1 as a reception destination of facsimile data under the control of the operation controller 521.

The control unit 51 includes the CPU 52 and a data storage 50. The CPU 52 is responsible for the operation control of the complex machine 1. The data storage 50 includes a communication destination storage 53 and a display priority storage 54.

The communication destination storage 53 is composed of a memory and the like and stores a communication method (facsimile communication, i fax transmission, electronic mail transmission, data transmission or the like to a personal computer network-connected to the complex machine 1) and communication destination specific information used for the communication method (address indicating a transmission destination of the electronic mail, address indicating the personal computer and its folder as a storage destination of document image data, facsimile number or the like) input through the operation of the operation unit 400 by the operator in correspondence with the communication destination indicated by the name input through the operation of the operation unit 400 by the operator. The communication destination storage 53 can store a plurality of pieces of communication destination information each composed of the communication method and the communication destination specific information in correspondence with one communication destination.

The display priority storage 54 is composed of a memory and the like and stores a display priority, which is used when the display controller 522 extracts the communication destination information to be displayed for each communication destination from a plurality of pieces of communication destination information stored in correspondence with one communication destination in the communication destination storage 53, for each communication destination information of this communication destination. For example, when designation of the communication destination information to be displayed for the communication destination is received by a display priority receiving section 525 from an operator, this designation of the communication destination information is stored as a display priority “high level” in the display priority storage 54. Further, the display priority storage 54 stores a value of a use frequency detected by a use frequency detecting section 527 as a display priority. Further, the display priority storage 54 stores a value of latest destination information detected by a latest destination information detecting section 528 as a display priority. Furthermore, the display priority storage 54 stores a value of latest storage information detected by a latest storage information detecting section 529 as a display priority.

Note that the display priority is an example of a selection criterion used when the communication destination and its corresponding communication destination information stored in the communication destination storage 53 are selected to be displayed on the display unit 410. Further, the display priority storage 54 is an example of a selection criterion storage which stores the selection criterion.

The CPU 52 includes the operation controller 521, the display controller 522, the communication destination receiving section 523, an extraction instruction receiving section 524, the display priority receiving section 525, an identification information receiving section 526, the use frequency detecting section 527, the latest destination information detecting section 528 and the latest storage information detecting section 529. The operation controller 521 is responsible for the operation control of the respective units (operation unit 400, scanner unit 11, image processing unit 21, printer unit 31, etc.) of the complex machine 1. The operation controller 521 controls, for example, communication by the network I/F unit 71 and that by the facsimile communication unit 75 as described above. The network I/F unit 71 and the facsimile communication unit 75 are an example of a communication unit in claims.

The display controller 522 controls the display operation of the display unit 410. The display controller 522 reads image data and the like necessary to display an operation screen from an unillustrated data storage, generates an address book screen C (FIG. 6 to be described later, an example of a communication destination list screen) together with the respective communication destinations and the communication destination information used for these stored in the communication destination storage 53 and displays the generated address book screen C on the display unit 410.

The communication destination receiving section 523 receives a communication destination and communication destination information for communication by the network I/F unit 71 and the facsimile communication unit 75 based on the operation of the operation unit 400 by the operator when the address book screen C is displayed on the display unit 410 by the display controller 522.

The extraction instruction receiving section 524 receives an extraction instruction to carry out the extraction by the display controller 522 based on the operation of the operation unit 400 by the operator. The display controller 522 extracts the communication destination information with a high display priority among those stored in the display priority storage 54 for each communication destination having a plurality of pieces of communication destination information and causes the display unit 410 to display the extracted information on the address book screen C when the extraction instruction is received by the extraction instruction receiving section 524 and the pieces of communication destination information are displayed on the display unit 410 for the respective communication destinations.

The display priority receiving section 525 receives designation of the communication destination information for the communication destination to be displayed by the display controller 522 from the operator as the display priority. The display controller 522 extracts the communication destination information to be displayed from a plurality of pieces of communication destination information for each communication destination including the plurality of pieces of communication destination information according to the display priority using the designation of the communication destination information as the display priority when the designation is received by the display priority receiving section 525.

The identification information receiving section 526 receives input of identification information for identification of respective operators (different IDs or the like allotted to the respective operators) for each different operator. When the identification information is received by the identification information receiving section 526, the display priority (designation of the communication destination information, value of use frequency, value of latest destination information or value of latest storage information) is stored in the display priority storage 54 for each piece of identification information received by the identification information receiving section 526. The display controller 522 extracts the communication destination information to be displayed from the plurality of pieces of communication destination information for each communication destination including the plurality of pieces of communication destination information according to the display priority of each piece of identification information stored in the display priority storage 54 for each different piece of identification information when the pieces of communication destination information of the respective communication destinations are displayed on the display unit 410.

The use frequency detecting section 527 detects a use frequency (e.g. number of uses per week) of each piece of communication destination information used in communication by the network I/F unit 71 and the facsimile communication unit 75 for each communication destination. The use frequency detected by the use frequency detecting section 527 is stored as a display priority in the display priority storage 54, and the display controller 522 extracts the communication destination information for the communication destination including the plurality of pieces of communication destination information using the value of the use frequency stored as the display priority.

The latest destination information detecting section 528 detects the communication destination information most recently used in communication by the network I/F unit 71 and the facsimile communication unit 75 for each communication destination. The latest destination information detected by the latest destination information detector 528 is stored as a display priority in the display priority storage 54 and the display controller 522 extracts the communication destination information for the communication destination including the plurality of pieces of communication destination information using the value of the latest destination information stored as the display priority.

The latest storage information detecting section 529 detects the communication destination information most recently stored in the communication destination storage 53 as latest storage information for each communication destination. The latest storage information detected by the latest storage information detecting section 529 is stored as a display priority in the display priority storage 54 and the display controller 522 extracts the communication destination information for the communication destination including the plurality of pieces of communication destination information using the value of the latest storage information stored as the display priority.

Note that the image display device according to one embodiment of the present invention includes some or all of the operation unit 400, the display unit 410, the display controller 522, the communication destination receiving section 523, the extraction instruction receiving section 524, the display priority receiving section 525, the identification information receiving section 526, the use frequency detecting section 527, the latest destination information detecting section 528, the latest storage information detecting section 529, the communication destination storage 53 and the display priority storage 54 necessary to perform processes according to respective embodiments to be described later and, additionally, includes at least one of the network I/F unit 71 and the facsimile communication unit 75.

A display control program according to one embodiment of the present invention is stored in a storage medium such as the HDD 74 in the complex machine 1, and the CPU 52 functions as the display controller 522, the communication destination receiving section 523, the extraction instruction receiving section 524, the display priority receiving section 525, the identification information detecting section 526, the use frequency detecting section 527, the latest destination information detecting section 528 and the latest storage information detecting section 529 and further causes a memory of the control unit 51 or the like to function as the communication destination storage 53 and the display priority storage 54 by executing an operation control in accordance with the display control program. This display control program is stored in the HDD 74 or the like by being read from a CD-ROM or DVD or downloaded from a server on Internet by the network I/F unit 71.

However, the display controller 522, the communication destination receiving section 523, the extraction instruction receiving section 524, the display priority receiving section 525, the identification information detecting section 526, the use frequency detecting section 527, the latest destination information detecting section 528 and the latest storage information detecting section 529 are not necessarily realized by the operation control of the CPU 52 in accordance with the display control program. The display controller 522, the communication destination receiving section 523, the extraction instruction receiving section 524, the display priority receiving section 525, the identification information detecting section 526, the use frequency detecting section 527, the latest destination information detecting section 528 and the latest storage information detecting section 529 may be provided as hardware in the form of circuits or the like.

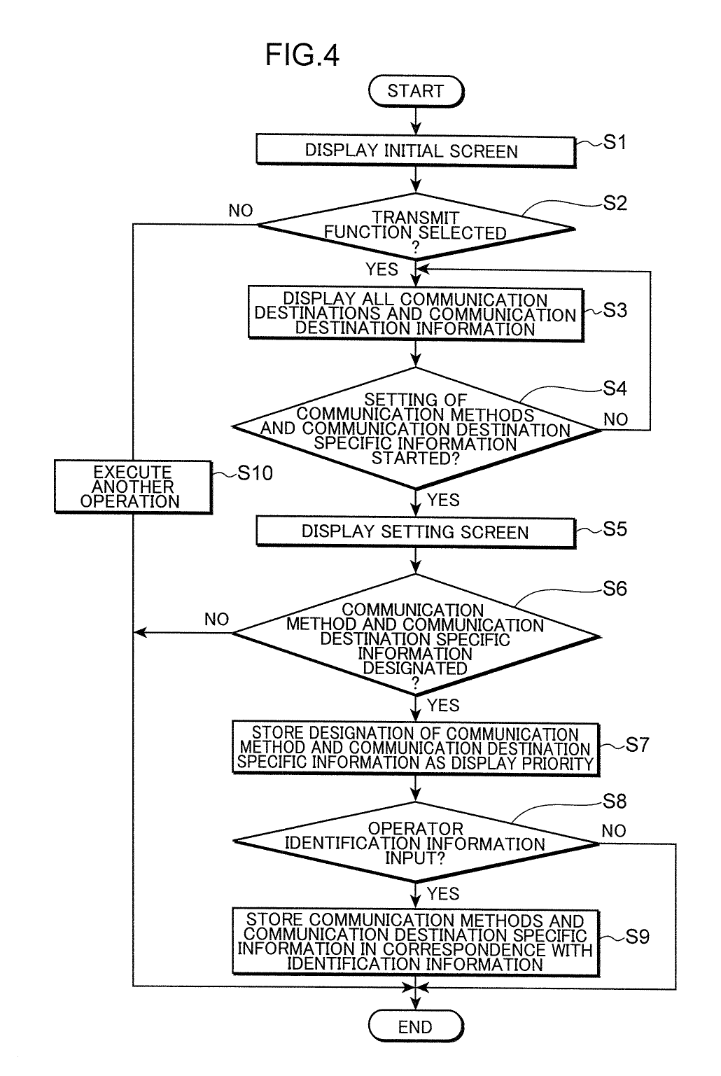

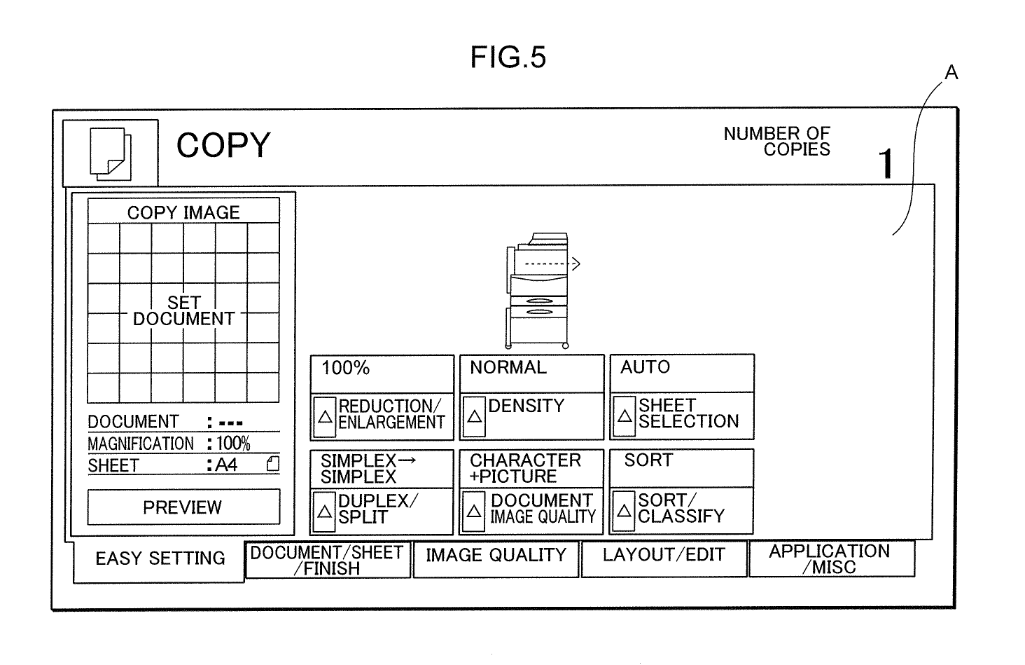

Next, there is described a process performed upon setting the display priority of the communication destination information for the communication destination in the complex machine 1. FIG. 4 is a flow chart showing a process performed upon setting the display priority of the communication destination information for the communication destination in the complex machine 1. FIGS. 5 to 8 are diagrams showing exemplary display screens of the display unit 410.

When a main power supply of the complex machine 1 is turned on by an operator, the display controller 522 causes the display unit 410 to display an initial screen A as shown in FIG. 5 (S1). In this embodiment, the display controller 522 shows an example of displaying a display screen, on which operation conditions of the copy function can be set, as an example of the initial screen A.

When an operation instruction other than those of the transmit function such as an instruction to execute a copying operation is input by the operator and received by the operation controller 521 while the display controller 522 is causing the display unit 410 to display the initial screen A (NO in S2), the input operation is executed by the operation controller 521 (S10).

When one of the function changeover keys 434, i.e. transmit key 434 of the operation key unit 430 is depressed by the operator and an instruction to start the transmit function for transmitting image data or the like obtained in the complex machine 1 to an external apparatus is received by the operation controller 521 based on this depressing operation while the display controller 522 is causing the display unit 410 to display the initial screen A (YES in S2), the display controller 522 reads all the communication destinations and communication destination information used for these from the communication destination storage 53, reads image data and the like necessary to display the address book screen C for receiving designation of the communication destination from the operator from an unillustrated storage, generates the address book screen C exemplarily shown in FIG. 6 using all the communication destinations and communication destination information used for these and the respective image data, and causes the display unit 410 to display the generated address book screen C (S3).

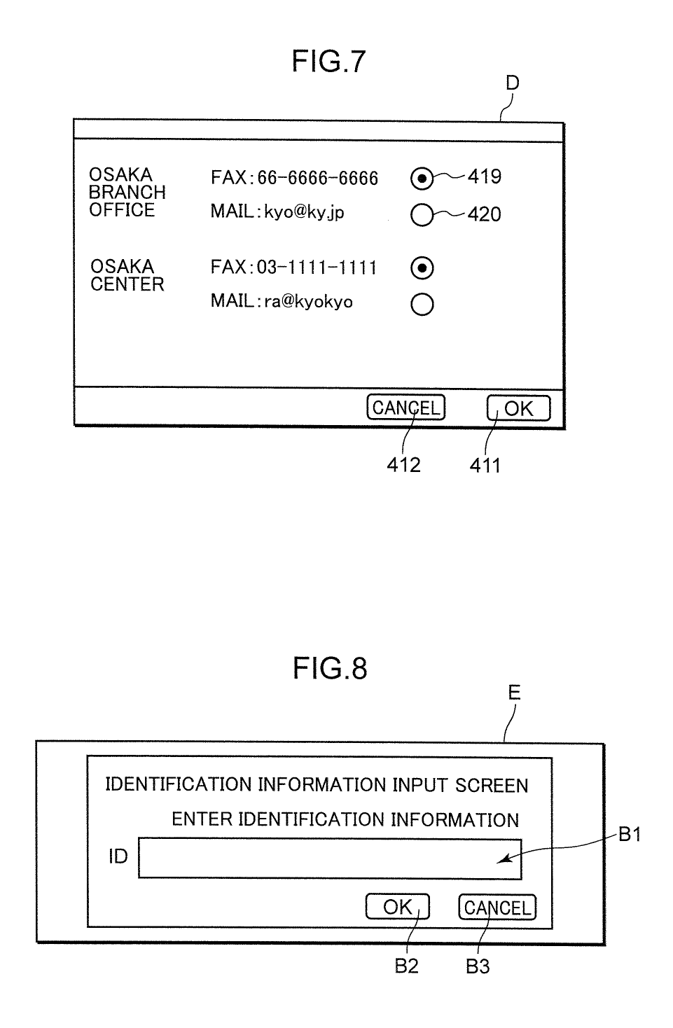

A display priority designation button 413 is displayed on the address book screen C displayed by the display controller 522. For example, when the display priority designation button 413 is pressed and the display priority receiving section 525 receives an instruction to start selection of the communication method and the communication destination specific information from the operator by the touch panel function (YES in S4), the display controller 522 causes the display unit 410 to display a setting screen D exemplarily shown in FIG. 7 (S5).

When a radio button 419 corresponding to “Name: Osaka Branch Office, Detail: 66-6666-6666” displayed as a facsimile transmission destination and then the OK button 411 are pressed by the operator during the display of this setting screen D, the display priority receiving section 525 receives designation of “Name: Osaka Branch Office, FAX:66-6666-6666” displayed as the facsimile transmission destination to be displayed for the communication destination “Osaka Branch Office” having a plurality of pieces of communication destination information (in this example, “Communication Method: Facsimile Communication, FAX: 66-6666-6666”, “Communication Method: Electronic Mail, Mail Address: kyo@ky.jp”) as a display priority (“display priority of “high level”) (YES in S6).

In other words, when the plurality of pieces of communication destination information “Communication Method: Facsimile Communication, FAX: 66-6666-6666” and “Communication Method: Electronic Mail, Mail Address: kyo@ky.jp” are stored in the communication destination storage 53 for one communication destination “Osaka Branch Office”, the display priority receiving section 525 receives “Name: Osaka Branch Office, Detail: 66-6666-6666” designated by pressing the radio button 419 and the OK button 411 as an item to be displayed next on the address book screen C for the communication destination “Osaka Branch Office” from the operator. If a plurality of radio buttons 419, 420 are pressed before the OK button 411 is pressed by the operator, the display priority receiving section 525 receives the plurality of pieces of communication destination information “Communication Method: Facsimile Communication, FAX: 66-6666-6666” and “Communication Method: Electronic Mail, Mail Address: kyo@ky.jp” for one communication destination “Osaka Branch Office” as items to be displayed next on the address book screen C for the communication destination “Osaka Branch Office”. The designation of the communication destination information received in this way is stored in the display priority storage 54 (S7).

After the receipt by the display priority receiving section 525, the display controller 522 returns the display screen of the display unit 410 to the address book screen C.

Further, when an identification information input button 414 is pressed on the address book screen C by the operator, the display controller 522 causes the display unit 410 to display an identification information input screen E exemplarily shown in FIG. 8. When operator identification information (user ID or the like), e.g. composed of a four-digit number is input by the operator, for example, through the operation of the numerical pad 433 of the operation unit 400, an OK button B2 is pressed and the input identification information is received by the identification information receiving section 526 (YES in S8), the communication destination information set by the operator in S7 and the input identification information are stored in correspondence in the display priority storage 54 (S9). Note that the display controller 522 causes the input number to be displayed in an identification number display field B1 of the identification information input screen E according to the input of the identification information by the operator.

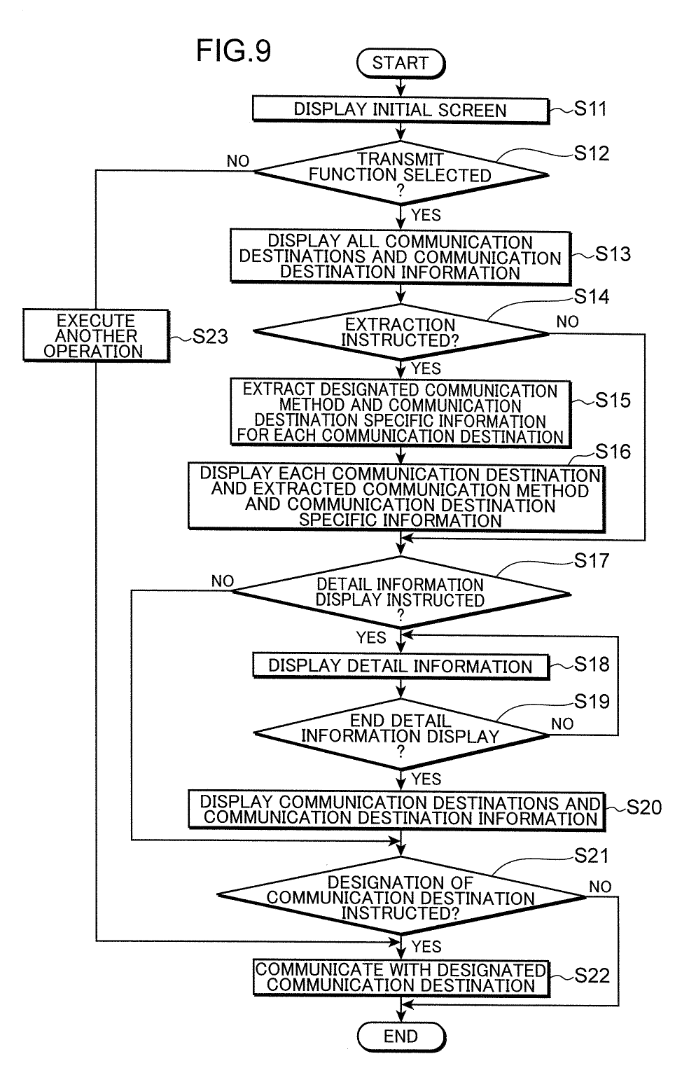

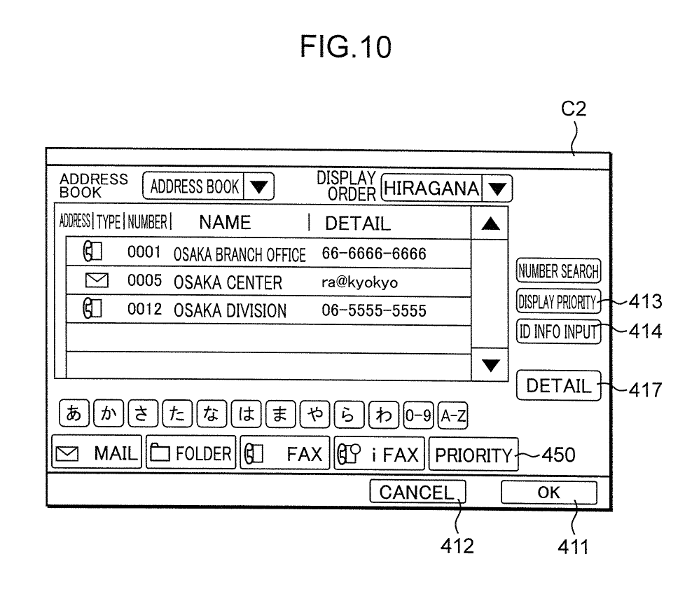

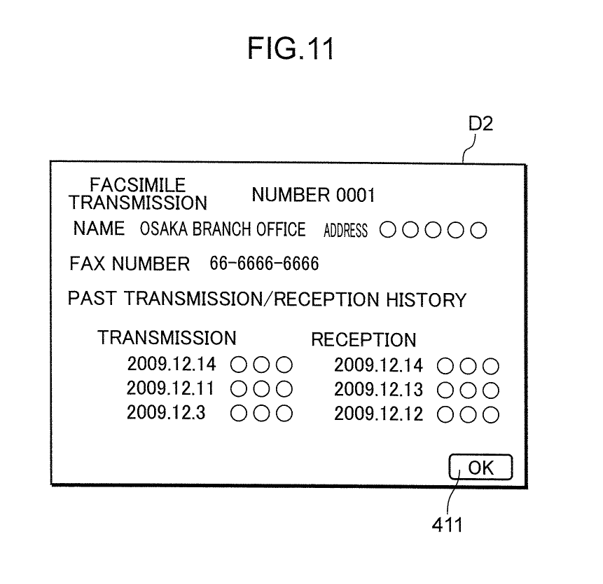

Next, there is described a first embodiment of a process of displaying the communication destinations and communication destination information by the complex machine 1. FIG. 9 is a flow chart showing the first embodiment of the process of displaying the communication destinations and communication destination information by the complex machine 1, and FIGS. 10 and 11 are diagrams showing exemplary display screens of the display unit 410. Note that processings similar to those shown in FIG. 4 are not described.

When a priority button 450 displayed on the address book screen C is pressed by the operator while the address book screen C (FIG. 6) is displayed by the display controller 522 (S13) and an extraction instruction is received by the extraction instruction receiving section 524 via the operation unit 400 by the touch panel function (YES in S14), the display controller 522 extracts the designated communication destination information (communication method and communication destination specific information) for each communication destination according to the display priority stored in the display priority storage 54 (S15).

The display controller 522 generates a new address book screen C2 exemplarily shown in FIG. 10 using each extracted piece of communication destination information (communication method and communication destination specific information) and the communication destination corresponding thereto and causes the new address book screen C2 to be displayed on the display unit 410 (S16). Note that if no extraction instruction is received in S14 (NO in S14), processings in S15 and S16 are skipped.

When a detail button 417 on the screen and a display part of the communication destination desired by the operator are pressed during the display of the new address book screen C2 and a detail information display instruction is received by the display controller 522 (YES in S17), the display controller 522 reads detail information (communication method, name of destination, address of destination, communication destination specific information, communication log, etc.) stored in the communication destination storage 53 for this communication destination and causes the display unit 410 to display a detail information screen D2 indicating this detail information as exemplarily shown in FIG. 11 (S18). When the OK button 411 is pressed during the display of the detail information screen D2 and an instruction to the effect of ending the display of the detail information screen D2 is received by the display controller 522 via the operation unit 400 by the touch panel function (YES in S19), the display controller 522 causes the display unit 410 to display the new address book screen C2 again (S20). If the detail display instruction is not received in S17 (NO in S17), processings of S18 to S20 are skipped and a processing of S21 is performed.

According to the present embodiment, the display controller 522 reads the detail information of the communication destination information, for which the detail information display instruction was received, from the communication destination storage 53 and causes the display unit 410 to display the read information. Thus, not only the communication destination information, but also the detail information can be presented to the operator for each communication destination.

When a display part of the desired communication destination is pressed on the new address book screen C2 and, then, the OK button 411 is pressed by the operator while the new address book screen C2 is displayed on the display unit 410 by the display controller 522, the communication destination displayed in the pressed part and the communication destination information (communication method and communication destination specific information used for this method) corresponding to the communication destination are received as the communication method and communication destination information used for communication this time by the operation unit 400 by the touch panel function. When the OK button 411 is pressed on the address book screen C by a touching operation of the operator after the receipt of this communication destination and communication destination information, the communication destination receiving section 523 receives these communication destination and communication destination information (YES in S21) and the operation controller 521 carries out communication with the received communication destination by the communication method and communication destination specific information indicated by the received communication destination information (S22). For example, if the OK button 411 is pressed after a display part of the communication destination information “Name: Osaka Branch Office, Detail: 66-6666-6666” shown as a facsimile transmission destination on the address book screen C is pressed by the operator during the display of the new address book screen C2, facsimile communication is carried out using the facsimile number of 66-6666-6666 by the facsimile communication unit 75.

In the above conventional communication apparatus, if a plurality of pairs of communication method and communication destination specific information used for this are registered for one communication destination, all the communication methods and communication destination specific information used for these registered for the respective communication destinations are displayed to make the display contents look complicated to an operator when the operator selects the communication destination, communication method and communication destination specific information used for this at the time of starting communication. Thus, it is not easy for the operator to find out the communication method and communication destination specific information used for communication with the communication destination this time out of the communication destinations, communication methods and communication destination specific information used for these displayed in a complicated manner.

However, according to the present embodiment, when displaying the communication destination information as a combination of the communication method and the communication destination specific information used for the communication method on the display unit 410 for each communication destination, the display controller 522 narrows down the number of pieces of communication destination information to be displayed according to the display priority for each communication destination including a plurality of pieces of communication destination information and displays the reduced number of pieces of communication destination information. Thus, it can be avoided that the display of the communication methods and communication destination specific information for the communication destinations looks complicated at the time of communication, wherefore the operator can easily designate the communication method and communication destination specific information used for communication with the communication destination this time out of the communication destinations, communication methods and communication destination specific information used for these registered in the apparatus.

Further, according to the present embodiment, the display controller 522 extracts the communication destination information with a high display priority for each communication destination and causes the display unit 410 to display the extracted information when the extraction instruction is received by the extraction instruction receiving section 524. Thus, the operator can select the display of all the pieces of communication destination information stored or the display of the extracted pieces of communication destination information for the respective communication destinations.

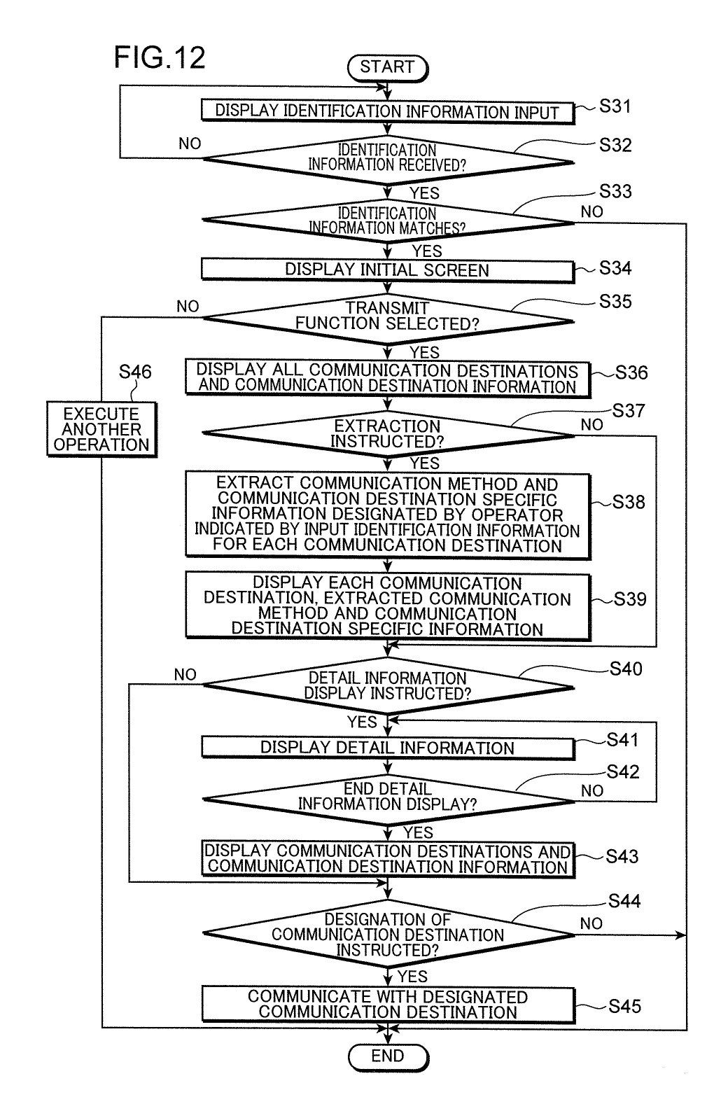

Next, there is described a second embodiment of the process of displaying the communication destinations and communication destination information by the complex machine 1. FIG. 12 is a flow chart showing the second embodiment of the process of displaying the communication destinations and communication destination information by the complex machine 1. Note that processings similar to those shown in FIG. 4 or 9 are not described.

In this second embodiment is described the process performed when an operator is logged in by inputting his identification information when the complex machine 1 is started and the complex machine 1 executes a display control and the like of the display unit 410 using contents corresponding to this operator.

When the complex machine 1 is started, the display controller 522 causes the display unit 410 to display an identification information input screen E similar to the one exemplarily shown in FIG. 8 (S31). When the identification information specific to the operator is input through the operation of the operation unit 400 by the operator during the display of this identification information input screen E and the identification information is received by the display controller 522 (YES in S32), the display controller 522 judges whether or not the received identification information matches legitimate information stored in an unillustrated legitimate information storage (predetermined identification information for allowing login to the complex machine 1) (S33) and causes an initial screen A to be displayed (S34) if judging that this information matches (YES in S33).

Thereafter, when the priority button 450 displayed on the address book screen C is pressed by the operator while the address book screen C is displayed on the display unit 410 by the display controller 522 and an extraction instruction is received by the extraction instruction receiving section 524 (YES in S37), the display controller 522 reads the display priority (designation of the communication destination information for each communication destination) stored in the display priority storage 54 in correspondence with the identification information received in S32 and extracts the designated communication destination information (communication method and communication destination specific information) for each communication destination based on the read display priority (S38). Then, the display controller 522 causes the display unit 410 to display the extracted communication destination information (communication method and communication destination specific information) for each communication destination on a new address book screen C2 (S39).

According to this display process, the operator can display only the communication destination information designated by the operator himself for each communication destination on the new address book screen C2 if he inputs the identification information to the complex machine 1.

Further, according to the present embodiment, the display controller 522 extracts the communication destination information to be displayed for each communication destination according to the display priority for each piece of the identification information. Thus, only information truly necessary for each operator can be displayed on the display unit 410.

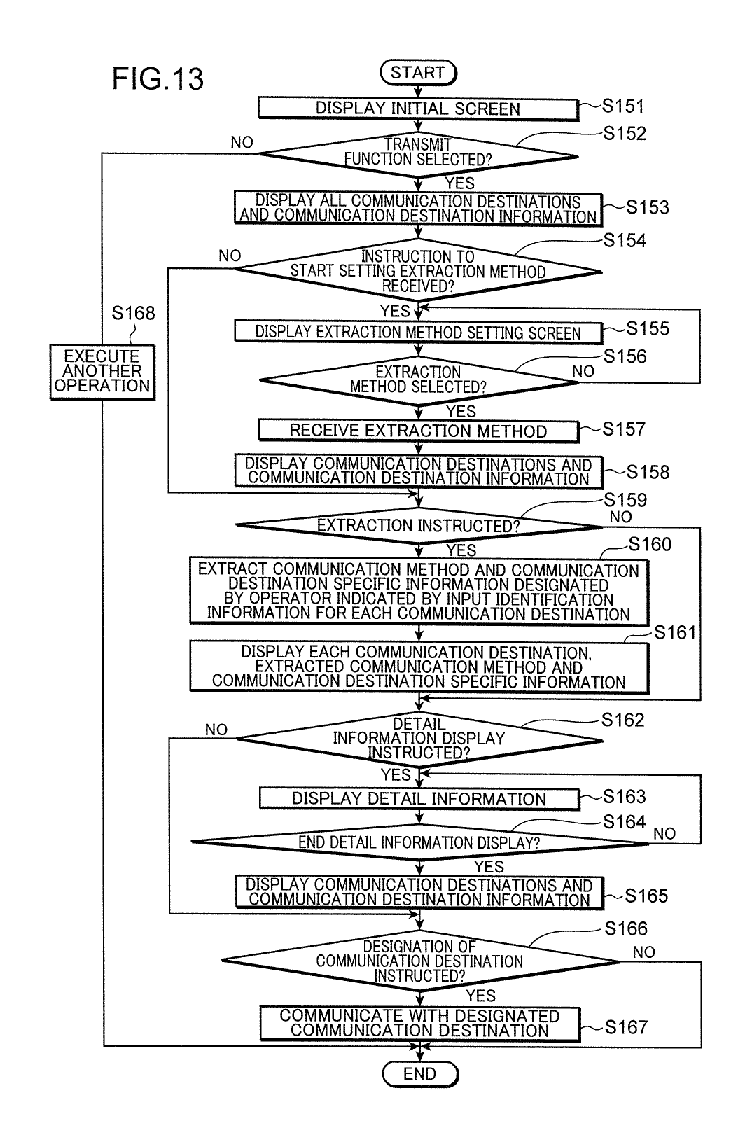

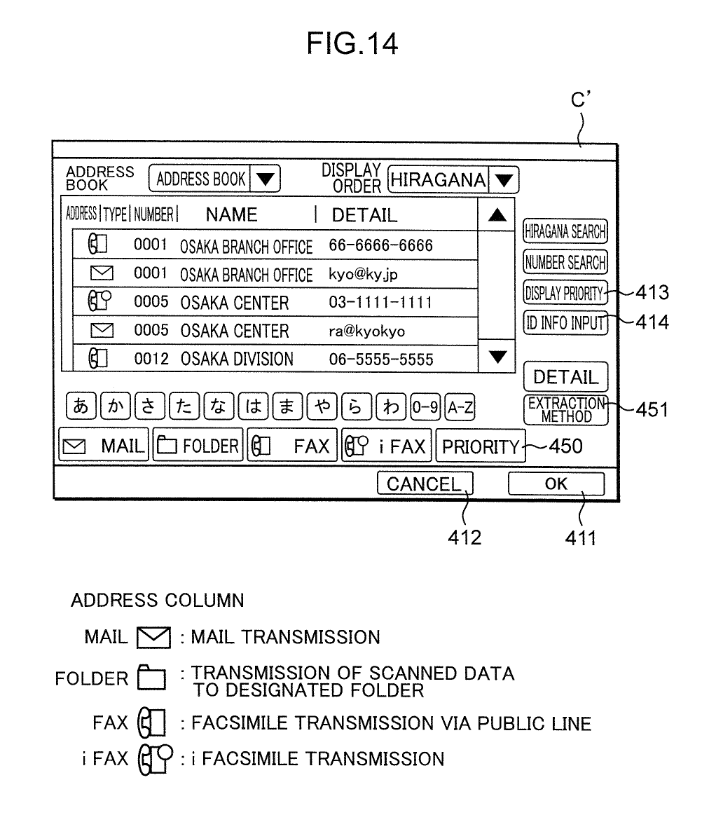

Next, there is described a third embodiment of the process of displaying the communication destinations and communication destination information by the complex machine 1. FIG. 13 is a flow chart showing the third embodiment of the process of displaying the communication destinations and communication destination information by the complex machine 1. FIGS. 14, 26 and 27 are diagrams showing exemplary display screens of the display unit 410. Note that processings similar to those shown in FIG. 4, 9 or 12 are not described.

The third embodiment is performed based on the display priority selected by an operator for extraction of the communication destination information (communication method and communication destination specific information) for each communication destination by the display controller 522.

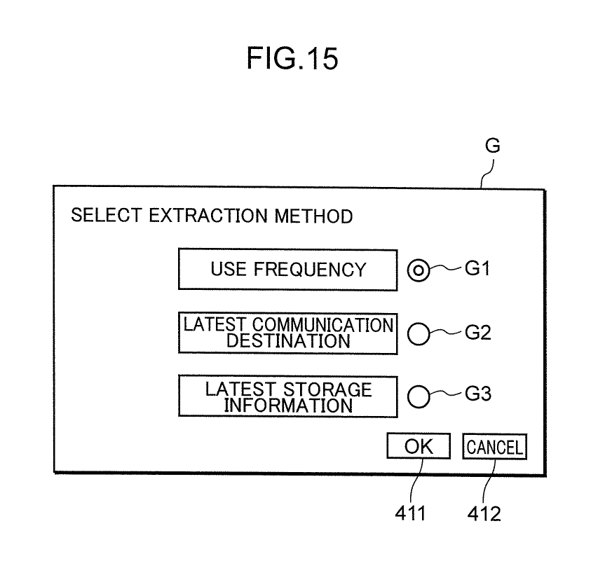

This is described with reference to FIG. 13. In this third embodiment, an extraction method setting button 451 is displayed on an address book screen C′ displayed by the display controller 522 as exemplarily shown in FIG. 14 (S153). For example, when this extraction method setting button 451 is pressed and the display priority receiving section 525 receives an instruction to start selection of an extraction method (YES in S154), the display controller 522 causes the display unit 410 to display an extraction method setting screen G as exemplarily shown in FIG. 15 (S155).

The display controller 522 causes this extraction method setting screen G to display respective methods selectable by the operator as an extraction method, e.g. use frequency, latest communication destination and latest storage information. When any one of radio buttons G1, G2 and G3 corresponding to the extraction method desired by the operator (any one of use frequency, latest communication destination and latest storage information) and then the OK button 411 are pressed by the operator (YES in S156), the extraction method corresponding to this radio button (in this example, any one of use frequency, latest communication destination and latest storage information) is received by the display controller 522 as an extraction method used for the extraction by the display controller 522 (S157). After receiving this, the display controller 522 causes the display unit 410 to display the address book screen C again (S158).

Thereafter, the display controller 522 extracts the communication destination information for each communication destination in accordance with the extraction instruction from the operator by the extraction method selected by the operator (S159, S160). For example, if the use frequency is selected by the operator and received as the extraction method by the display controller 522, the display controller 522 refers to the use frequency detected by the use frequency detecting section 527 for each piece of communication destination information stored in correspondence with each communication destination and extracts, for example, the communication destination information with a highest use frequency from the respective pieces of communication destination information stored in correspondence with each communication destination as the communication destination information to be displayed for the communication destination. In this case, the display controller 522 may extract all the pieces of communication destination information whose use frequencies have reached a predetermined value. In other words, the display controller 522 uses information (values) indicating all the pieces of communication destination information whose use frequencies have reached the predetermined value as the display priority.

According to the present embodiment, the display controller 522 extracts the communication destination information to be displayed for each communication destination according to the display priority indicated by designation received from the operator by the display priority receiving section 525. Thus, the communication destination information desired by the operator can be displayed on the display unit 410 for each communication destination.

Further, according to the present embodiment, the display controller 522 discriminates the communication destination information to be displayed for each communication destination including a plurality of pieces of communication destination information using a use frequency detected by the use frequency detecting section 527 as the display priority. Thus, the communication destination information with a high use frequency, which information will be desired by the operator with high probability, can be displayed on the display unit 410 for each communication destination.

For example, if the latest destination is selected by the operator and received as the extraction method by the display controller 522, the display controller 522 extracts the latest destination information detected by the latest destination information detecting section 528 as communication destination information to be displayed for each communication destination. In this case, the latest destination information detecting section 528 detects the latest communication destination information used for communication by the network I/F unit 71 and the facsimile communication unit 75 for each communication destination. The latest destination information detected by the latest destination information detecting section 528 is stored as a display priority in the display priority storage 54 and the display controller 522 extracts the communication destination information for each communication destination including the plurality of pieces of communication destination information using the value of the latest destination information stored as the display priority.

According to the present embodiment, the display controller 522 discriminates the communication destination information to be displayed for each communication destination including a plurality of pieces of communication destination information using a detection result by the latest destination information detecting section 528 as the display priority. Thus, the communication destination information used in the most recent communication, which information will be desired by the operator with high probability, can be displayed on the display unit 410 for each communication destination.

Further, in this case, the latest destination information detecting section 528 may store a history of the communication destination information of each communication destination used for communication by the network I/F unit 71 and the facsimile communication unit 75 and detect a predetermined number of pieces of communication destination information from the latest communication destination information based on this history and the display controller 522 may extract all the detected pieces of communication destination information. In other words, the display controller 522 uses information (values) indicating all the detected pieces of communication destination information as a display priority.

For example, if the latest storage information is selected by the operator and received as the extraction method by the display controller 522, the display controller 522 extracts the latest storage information (communication destination information most recently stored in the communication destination storage 53) detected by the latest storage information detecting section 529 as communication destination information to be displayed for the communication destination.

Further, in this case, the latest storage information detecting section 529 may store a history of the communication destination information of each communication destination stored in the communication destination storage 53 and detect a predetermined number of pieces of communication destination information from the most recently stored communication destination information based on this history and the display controller 522 may extract all the detected pieces of communication destination information. In other words, the display controller 522 uses information (values) indicating all the detected pieces of communication destination information as a display priority.

According to the present embodiment, the communication destination information to be displayed is discriminated for each communication destination including a plurality of pieces of communication destination information using a detection result of the latest storage information detecting section 529 as the display priority. Thus, the communication destination information most recently stored in the communication destination storage 53, which will be desired by the operator with high probability, can be displayed on the display unit 410 for each communication destination.

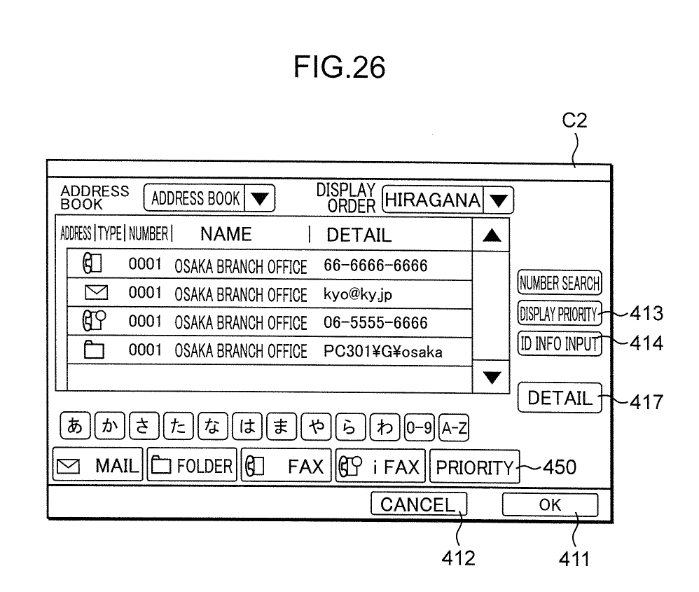

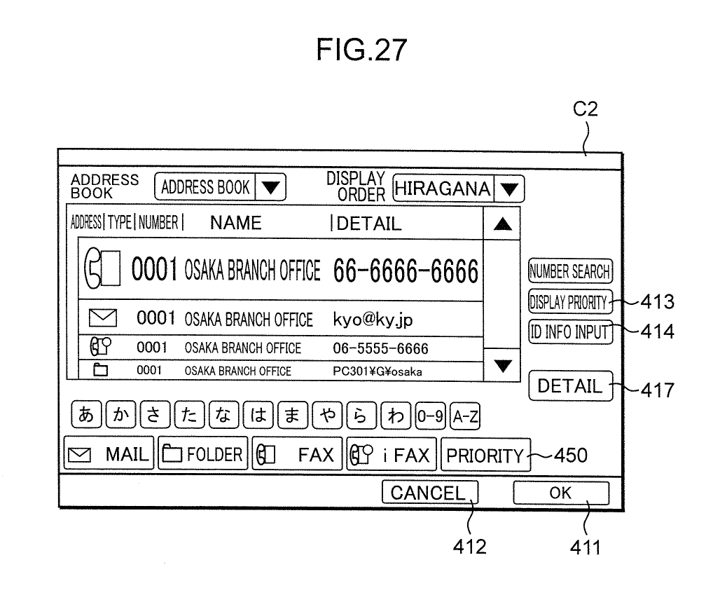

When the display controller 522 extracts a plurality of pieces of communication destination information according to the display priority for each communication destination including the plurality of pieces of communication destination information as described above, a new address book screen C2 (FIG. 26) on which the extracted pieces of communication destination information are arranged from top in an order of use frequencies, a reverse chronological order as to use for communication or a reverse chronological order as to storage in the communication destination storage 53 (i.e. each order is used as a display priority) may be generated and displayed on the display unit 410. According to the present embodiment, the display controller 522 displays the pieces of communication destination information extracted for each communication destination in an order of the display priority. Thus, each operator can confirm the pieces of communication destination information arranged in a presumably decreasing order of necessity. In this case, more preferably, the display controller 522 may cause the display unit 410 to display the extracted plurality of pieces of communication destination information in different display modes according to the display priority (for example by reducing the display size in a decreasing order of display priority) as shown in FIG. 27.

As a method for making the display modes different, in addition to making the display sizes different as described above, the display controller 522 may make display colors different (for example, the information with a high display priority is in an easily recognizable color such as red and the display colors are successively changed to less easily recognizable colors as the display priority decreases) or make fonts or the like different (for example, the information with a high display priority is in an easily recognizable font such as bold Gothic font and the fonts are successively changed to less easily recognizable fonts (such as thin Roman font) as the display priority decreases).

According to the present embodiment, the display controller 522 displays the pieces of communication destination information extracted for each communication destination in different display modes in the order of the display priority. Thus, each operator can easily confirm a degree of necessity of each displayed piece of communication destination information.

In the display process of this third embodiment, as in the second embodiment shown in FIG. 12, an identification information receiving process similar to S31 to S33 (FIG. 12) for receiving the input of the identification information of the operator may be similarly applied before a processing of S151 and, in an extraction processing of S160, the display controller 522 may read the extraction method stored in the display priority storage 54 in correspondence with the identification information received in the identification information receiving process and extract the designated communication destination information (communication method and communication destination specific information) for each communication destination based on the read extraction method. In this case, for the correspondence between the extraction method and the identification information, a series of processings are performed. Specifically, the designation of the extraction method (in this example, any one of use frequency, latest communication destination or latest storage information) for each communication destination may be received instead of receiving the designation of the communication destination information (communication method and communication destination specific information used for this) for each communication destination in the processings of S4 to S7 of the display priority setting process shown in FIG. 4 and the received extraction method may be stored in the display priority storage 54 as in S9 of FIG. 4 in correspondence with the identification information received in S8 of FIG. 4.

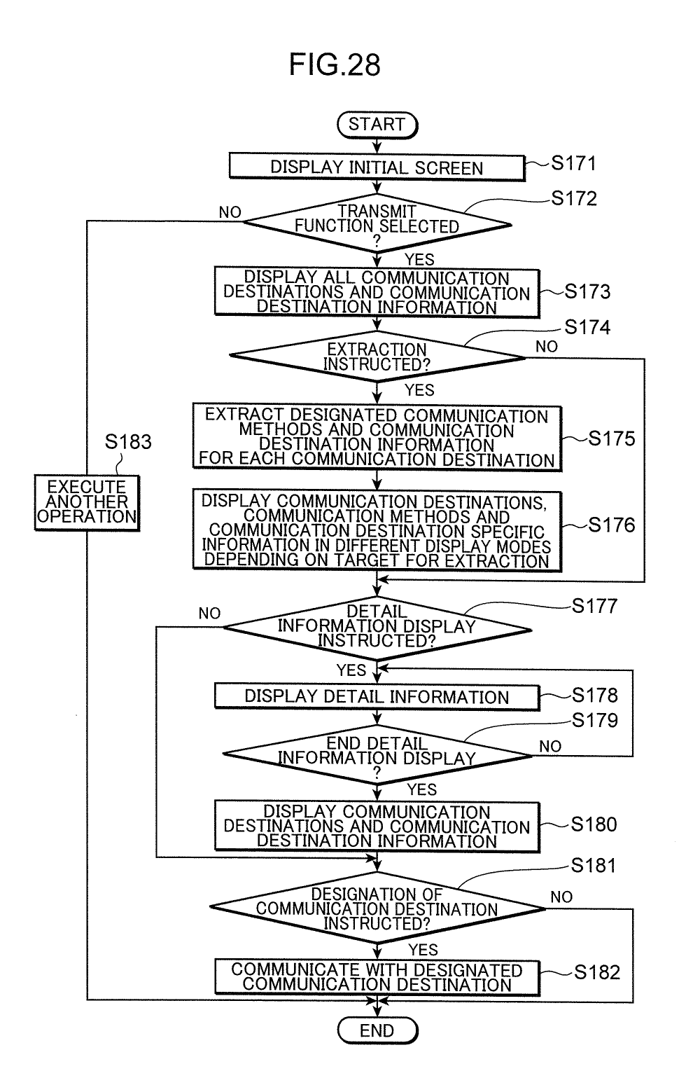

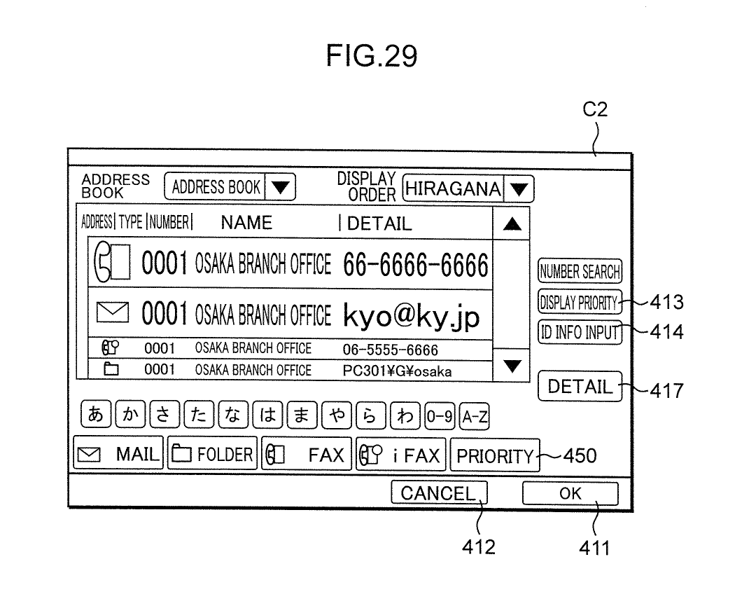

Next, there is described a fourth embodiment of the process of displaying the communication destinations and communication destination information by the complex machine 1. FIG. 28 is a flow chart showing the fourth embodiment of the process of displaying the communication destinations and communication destination information by the complex machine 1. FIG. 29 is a diagram showing an exemplary display screen of the display unit 410. Note that processings similar to those shown in FIG. 4, 9, 12 or 13 are not described.

In the fourth embodiment, when extracting the communication destination information (communication method and communication destination specific information) for each communication destination according to the display priority (S175) and generating an address book screen C2, the display controller 522 generates the address book screen C2 further including pieces of communication destination information that are not target for extraction according to the display priority. At this time, the display controller 522 generates such an address book screen C2 that the pieces of communication destination information extracted according to the display priority are displayed in a different mode from those that are not target for extraction and displays the address book screen C2 on the display unit 410 (S176).

For example, the display controller 522 generates the address book screen C2 displaying the pieces of communication destination information extracted according to the display priority larger than those that are not target for extraction as shown in FIG. 29 and displays the address book screen C2 on the display unit 410.

As a method for making the display modes different, in addition to making the display sizes different as described above, the display controller 522 may make display colors different (for example, the pieces of communication destination information extracted according to the display priority are in an easily recognizable color such as red and the pieces of communication destination information that are not target for extraction are successively changed to less easily recognizable colors) or make shapes such as fonts different (for example, the pieces of communication destination information extracted according to the display priority are in an easily recognizable font such as bold Gothic font and the pieces of communication destination information that are not target for extraction are successively changed to less easily recognizable fonts (such as thin Roman font)).

According to the present embodiment, the display controller 522 causes the display unit 410 to further display pieces of communication destination information, which are not target for extraction, such that the extracted pieces of communication destination information and the pieces of communication destination information that are not the target for extraction are displayed in different display modes. Thus, all the pieces of communication destination information can be confirmed regardless of whether or not the communication destination information is the target for extraction, and whether or not the communication destination information is the target for extraction can be easily recognized based on the different display modes.

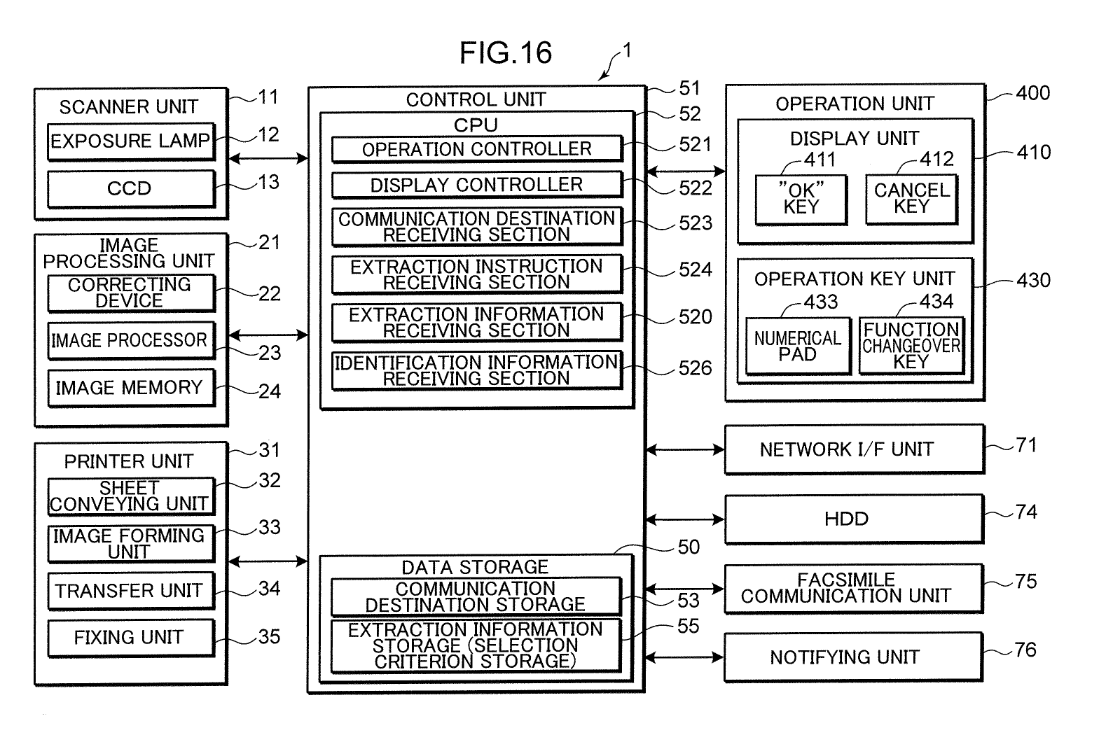

Next, there is described a fifth embodiment of the process of displaying the communication destinations and communication destination information by a complex machine 1. FIG. 16 is a control block diagram of the complex machine 1 for performing the process according to the fifth embodiment. Note that a construction similar to that shown in FIG. 3 is not described.

A CPU 52 of the complex machine 1 for performing the process according to the fifth embodiment includes an extraction information receiving section 520 in addition to an operation controller 521, a display controller 522, a communication destination receiving section 523, an extraction instruction receiving section 524 and an identification information receiving section 526.

The extraction information receiving section 520 receives input of extraction information used for extraction of items to be displayed on a display unit 410 by the display controller 522 from an operator for communication destinations and communication destination information used for these stored in a communication destination storage 53. An extraction information storage 55 stores the extraction information received by the extraction information receiving section 520 in correspondence with the communication destinations and communication destination information used for these stored in the communication destination storage 53. When causing the display unit 410 to display the respective communication destinations and communication destination information used for these, the display controller 522 extracts the communication destinations and communication destination information corresponding to the extraction information received by the extraction information receiving section 520 from the communication destination storage 53 and displays them on the display unit 410.

Note that the extraction information is an example of a selection criterion used when the communication destinations and their corresponding communication destination information stored in the communication destination storage 53 are selected as items to be displayed on the display unit 410. Further, the extraction information storage 55 is an example of a selection criterion storage for storing the selection criterion.

The extraction information receiving section 520 can receive designation of the extraction information used for extraction by the display controller 522 together with designation of hours for extraction in accordance with the former designation from the operator. The extraction information received by the extraction information receiving section 520 and the hours corresponding to the extraction information are stored in the communication destination storage 53. When causing the display unit 410 to display the respective communication destinations and the communication destination information used for these, the display controller 522 extracts all the communication destinations and communication destination information used for these from the communication destination storage 53 according to the extraction information and hours (hours designated for extraction using this extraction information) stored in the communication destination storage 53 and causes the display unit 410 to display them.

In other words, in this fifth embodiment, the display controller 522 extracts specific communication destinations from the respective communication destinations stored in the communication destination storage 53 according to the extraction information set by the operator and causes the display unit 410 to display them. The extraction information receiving section 520 receives the extraction information, for example, either as private extraction information or common extraction information for each pair of the communication destination and communication destination information used for this stored in the communication destination storage 53. In the case of receiving an instruction to extract the communication destination(s) and the communication destination information used for this/these to which the private extraction information is attached, the display controller 522 extracts each communication destination and communication destination information used for this corresponding to the private extraction information from the communication destination storage 53 and causes the display unit 410 to display each extracted communication destination and communication destination information used for this.

If the extraction information receiving section 520 receives designation of the hours during which extraction should be carried out as extraction information indicating private or business from the operator, the display controller 522 carries out extraction using a different piece of extraction information for designated hours measured, for example, by a built-in timer capable of measuring time. For example, if the extraction information designates hours from 8 AM to 6 PM as business hours and hours from 6 PM to 8 AM as private hours, the display controller 522 extracts the communication destination storage and the communication destination information whose extraction information indicates business from 8 AM to 6 PM and extracts the communication destination storage and the communication destination information whose extraction information indicates private from 6 PM to 8 AM.

Further, the storage 50 includes the communication destination storage 53 and the extraction information storage 55. The extraction information storage 55 stores the extraction information received from the operator by the extraction information receiving section 520 and, if the hours are designated for the extraction information, the hours.

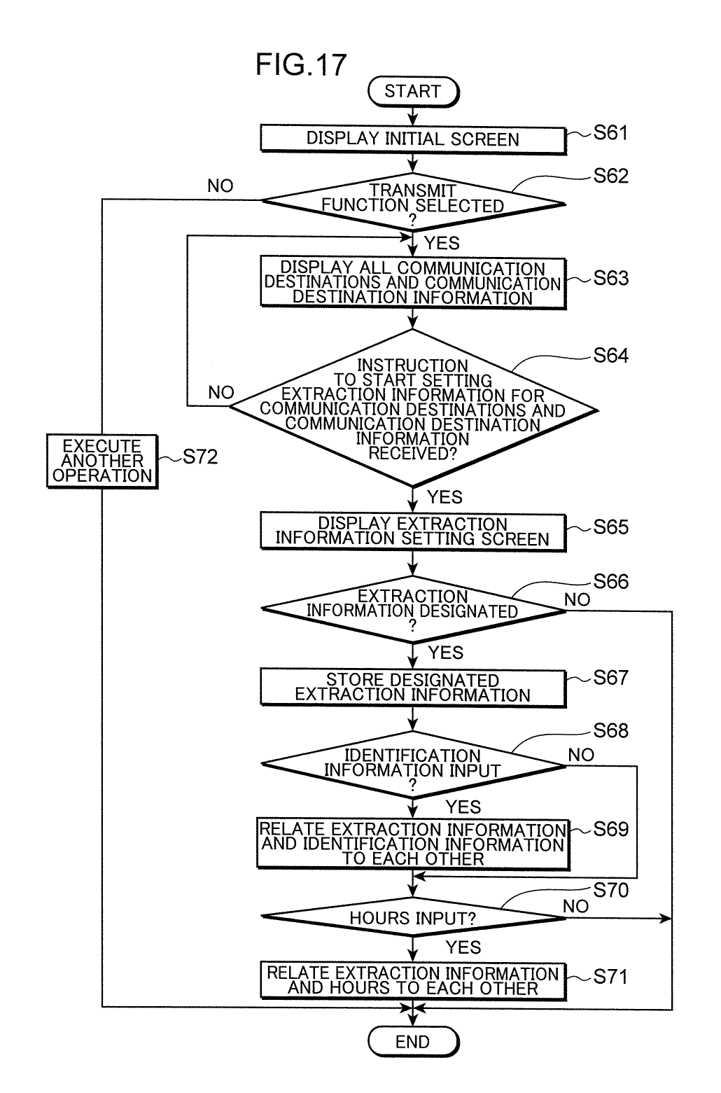

Next, there is described a process performed upon setting the extraction information used to extract the communication destination and communication destination information used for this in the complex machine 1. FIG. 17 is a flow chart showing the process performed upon setting the extraction information used to extract the communication destination and communication destination information used for this in the complex machine 1. Note that processings similar to those shown in FIG. 4 are not described.

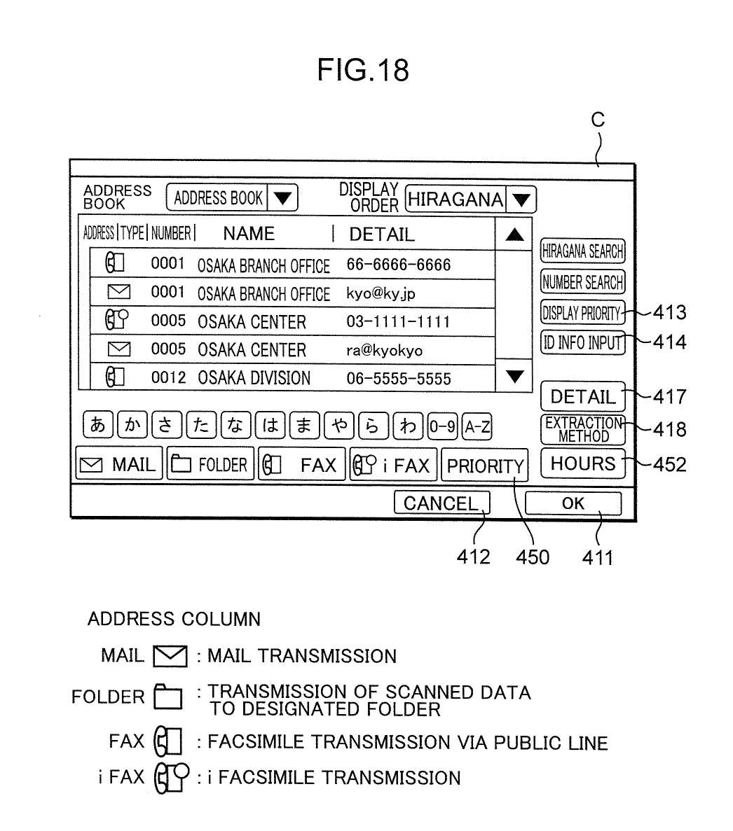

When the display controller 522 causes the display unit 410 to display an address book screen C displaying all the communication destinations and communication destination information used for these (S63), an extraction information receiving button 418 is displayed on this address book screen C as exemplarily shown in FIG. 18. This extraction information receiving button 418 is for receiving an instruction to start setting the extraction information for the communication destinations and communication destination information from the operator by the touch panel function.

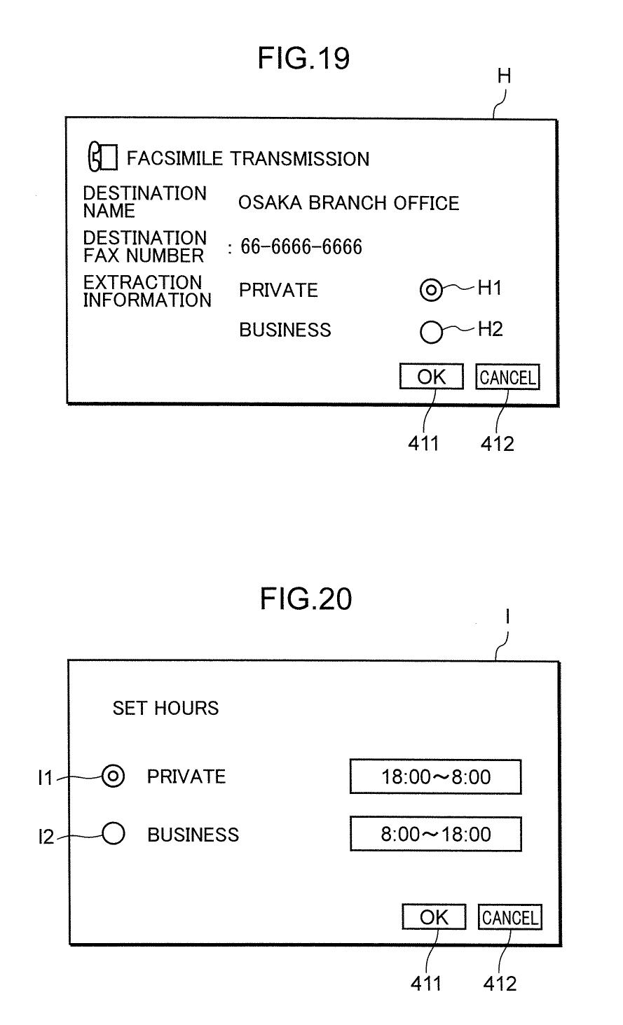

Here, when the extraction information receiving button 418 and a display part of the communication destination and the communication destination information, for which the extraction information is desired to be set, are pressed, for example, by the operator and the extraction information receiving section 520 receives designation of the communication destination and communication destination information for which the extraction information is to be set and an instruction to start setting the extraction information for the communication destination and communication destination information from the operator by the touch panel function (YES in S64), the display controller 522 causes the display unit 410 to display such an extraction information setting screen H as exemplarily shown in FIG. 19 (S65).

When a private radio button H1 is pressed out of the private radio button H1 and a business radio button H2 provided in correspondence with a facsimile communication destination “Name: Osaka Branch Office, Detail: 66-6666-6666” displaying the communication destination and communication destination information for which the extraction information is to be set and then the OK button 411 is pressed by the operator during the display of the extraction information setting screen H (YES in S66), “private” is received as the extraction information by the extraction information receiving section 520, correspondence between the facsimile communication destination “Name: Osaka Branch Office, Detail: 66-6666-6666” and the extraction information “private” is established and the correspondence and the extraction information “private” are stored in the extraction information storage 55 (S67).

After the receipt of the extraction information by this extraction information receiving section 520, the display controller 522 returns the display screen of the display unit 410 to the address book screen C.

Further, when an identification information input button 414 is pressed on the address book screen C by the operator, the display controller 522 causes the display unit 410 to display the identification information input screen E exemplarily shown in FIG. 8. When operator identification information (user ID or the like) is input by the operator and an OK button B2 is pressed by him during the display of the screen E (YES in S68), the input identification information is stored in the extraction information storage 55 in correspondence with the extraction information stored in the extraction information storage 55 in S67 in correspondence with the communication destination and the communication destination information (S69). Note that if the OK button B2 is pressed without the operator identification information being input by the operator (NO in S68), this routine skips to S70.

After the receipt of the extraction information by this extraction information receiving section 520, the display controller 522 returns the display screen of the display unit 410 to the address book screen C.

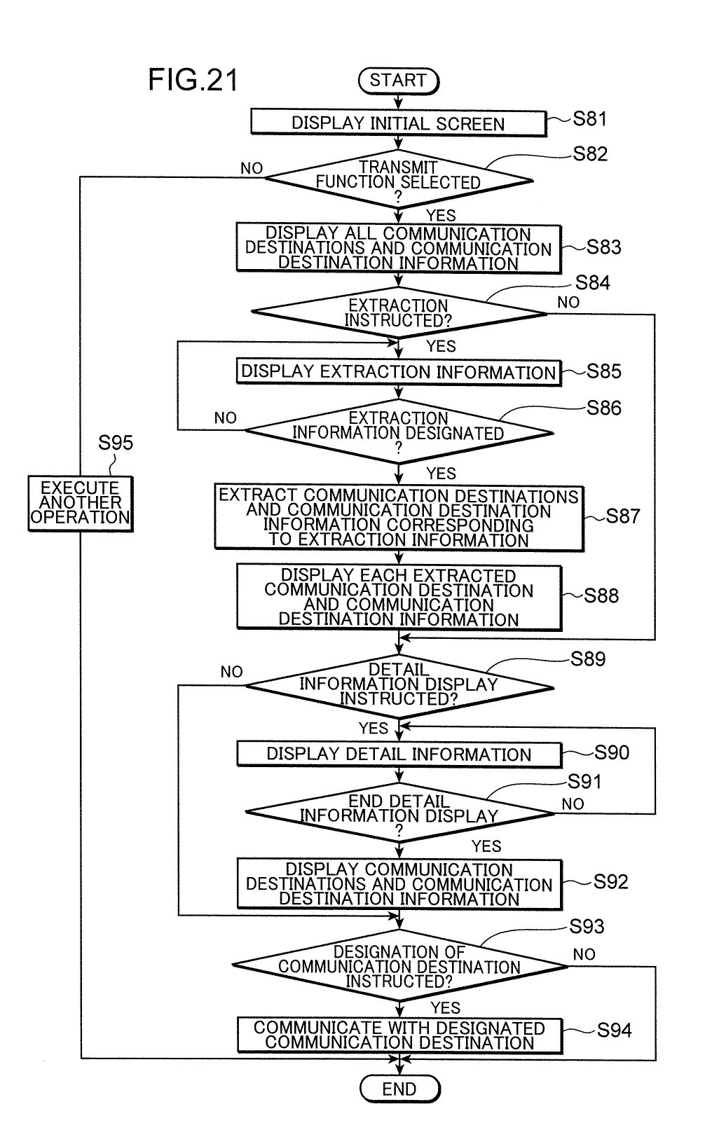

Subsequently, when an hour setting button 452 displayed on the address book screen C is pressed by the operator and an instruction to start a hour setting process is received by the extraction information receiving section 520 by the touch panel function, the display controller 522 causes the display unit 410 to display a hour setting screen I exemplarily shown in FIG. 20.

When desired hours are input, for example, through the operation of the numerical pad 433 by the operator and the OK button 411 is pressed to designate the hours for each piece of extraction information (YES in S70) after either one of radio buttons Il, I2 corresponding to the extraction information (in this embodiment, private or business) desired by the operator is pressed during the display of the screen I whereby the extraction information concerning the extraction hours is selected by the operator, the designated hours are received by the extraction information receiving section 520 and the received extraction information and the hours for this are stored in the extraction information storage 55 (S71). Note that the operator may not set the hours by not pressing the hour setting button 452 (NO in S70).

By S64 to S71, the extraction information and the identification information can be set for each communication destination and all the pieces of communication destination information used for this.

According to the present embodiment, when causing the display unit 410 to display the respective communication destinations and the communication destination information used for these, the display controller 522 extracts the communication destinations and the communication destination information used for these in correspondence with extraction information received by the extraction information receiving section 520 from the communication destination storage 53 and causes the display unit 410 to display them. Thus, it can be avoided that the display of the communication methods and communication destination specific information for the communication destinations looks complicated at the time of communication, wherefore the operator can easily designate the communication method and communication destination specific information used for communication with the communication destination this time out of the communication destinations, communication methods and communication destination specific information used for these registered in the apparatus.

Further, according to the present embodiment, the display controller 522 extracts the communication destinations and communication destination information used for these according to the extraction information when an extraction instruction is received by the extraction instruction receiving section 524. Thus, the operator can select the display of all the communication destinations and communication destination information used for these stored or the display of the extracted communication destinations and communication destination information used for these for the respective communication destinations.

Further, according to the present embodiment, the display controller 522 reads extraction information corresponding to hours for the extraction from the extraction information storage 55, extracts the communication destinations and communication destination information used for these in correspondence with the read extraction information and causes the display unit 410 to display them. Thus, the operator can make the extraction different depending on the hours.

FIG. 21 is a flow chart showing a fifth embodiment of the process of displaying the communication destinations and communication destination information by the complex machine 1. Note that processings similar to those shown in FIG. 4, 9, 12, 13 or 28 are not described.

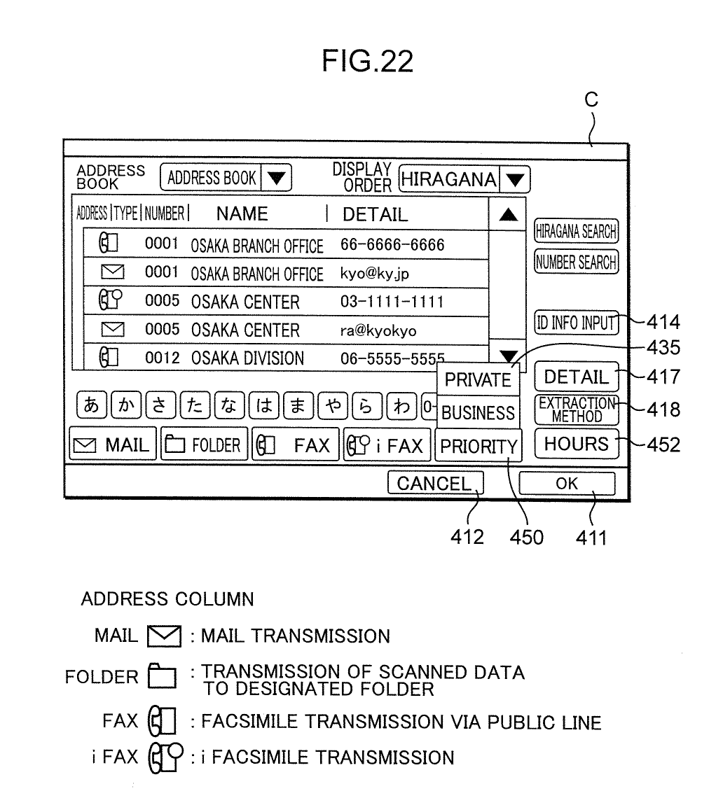

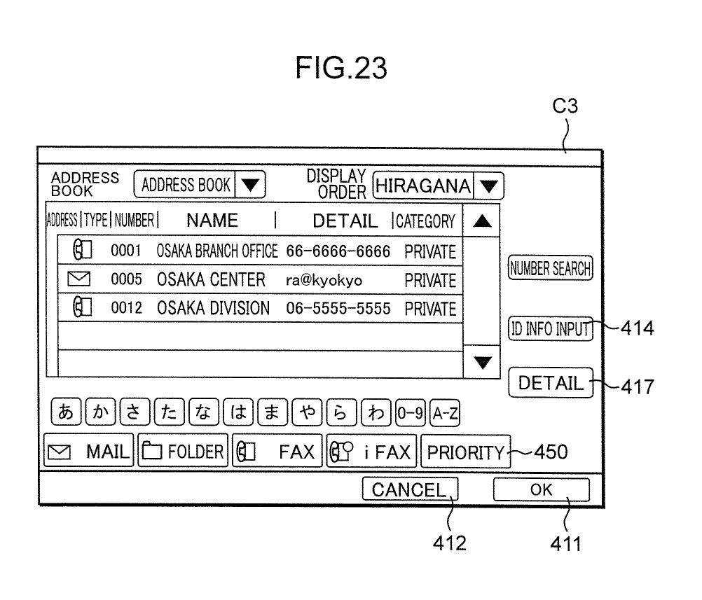

When the priority button 450 displayed on the address book screen C is pressed by the operator and an extraction instruction is received by the extraction instruction receiving section 524 (YES in S84) while the address book screen C (e.g. FIG. 18) is displayed by the display controller 522 using all the communication destinations and communication destination information used for these stored in the communication destination storage 53, the display controller 522 causes the display unit 410 to display all the pieces of extraction information set by the operator through the display of a pull-up menu 435 as exemplarily shown in FIG. 22 (S85). Here, if a display part of the extraction information desired by the operator, e.g. a private display part is pressed by the operator and designation of the private extraction information is received by the display controller 522 (YES in S86), the display controller 522 judges the respective communication destinations and communication destination information in correspondence with the designated extraction information, i.e. the private extraction information in this embodiment, based on the contents stored in the extraction information storage 55 and extracts the respective communication destinations and communication destination information in correspondence with the designated extraction information (S87). The display controller 522 generates a new address book screen C3 as exemplarily shown in FIG. 23 using this extraction result and causes the display unit 410 to display the generated address book screen C3 (S88).

When the detail button 417 and then a display part of the communication destination desired by the operator are pressed during the display of this new address book screen C3 (or address book screen C) (YES in S89), the display controller 522 reads the detail information stored in the communication destination storage 53 for the desired communication destination and causes the display unit 410 to display the detail information on the detail information screen D2 as exemplarily shown in FIG. 11 (S90).

When the OK button 411 is pressed by the operator during the display of the detail information screen D2 and an instruction to end the display of the detail information screen D2 is received by the display controller 522 via the operation unit 400 by the touch panel function (YES in S91), the display controller 522 causes the display unit 410 to display the new address book screen C3 (address book screen C unless the new address book screen C3 is generated) again (S92). If the detail display instruction is not received in S89 (NO in S89), processings of S90 to S92 are skipped and a display processing of S93 is performed.

When the display part of the desired communication destination on the new address book screen C3 is pressed by a touching operation of the operator during the display of the new address book screen C3 (or address book screen C) on the display unit 410 by the display controller 522, the communication destination displayed in the pressed part and the communication method stored in correspondence with this communication destination in the communication destination storage 53 are received as the communication destination and communication method this time by the communication destination receiving section 523 via the operation unit 400 by the touch panel function (YES in S93).

When the OK button 411 on the address book screen C3 (or address book screen C) is pressed by a touching operation of the operator after the receipt of the communication destination and the communication method in S93, the operation controller 521 carries out communication with the received communication destination by the received communication method (S94).

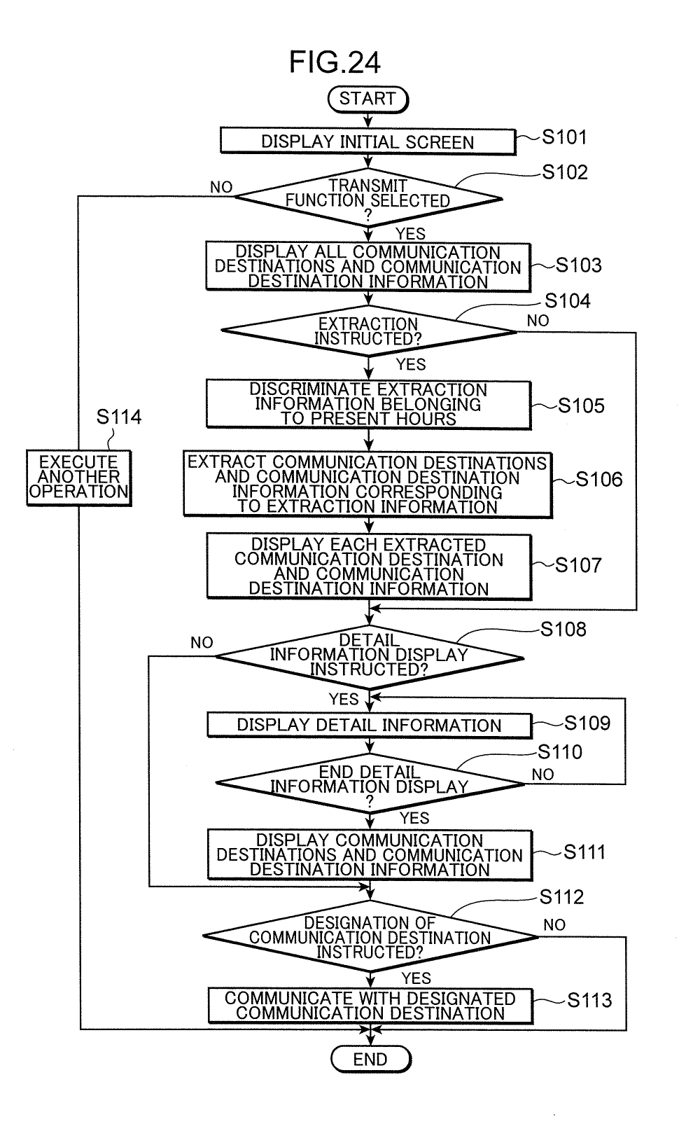

Next, there is described a first modification of the fifth embodiment of the process of displaying the communication destinations and communication destination information by the complex machine 1. FIG. 24 is a flow chart showing the first modification of the fifth embodiment of the process of displaying the communication destinations and communication destination information by the complex machine 1. Note that processings similar to those shown in FIG. 21 and other figures are not shown.

In this modification, when the priority button 450 displayed on the address book screen C is pressed by an operator and an extraction instruction is received by the extraction instruction receiving section 524 (YES in S104) while the address book screen C is displayed by the display controller 522 using all the communication destinations and communication destination information used for these stored in the communication destination storage 53, the display controller 522 judges the present time, for example, by a built-in timer and discriminates the extraction information stored in the extraction information storage 55 in correspondence with the hours to which the present time belongs (S105) and extracts all the pairs of communication destination and communication destination information in correspondence with this extraction information from the communication destination storage 53 (S106). The display controller 522 generates a new address book screen C3 as exemplarily shown in FIG. 23 using this extraction result and causes the display unit 410 to display the generated address book screen C3 (S107). Succeeding processings of S108 to S114 are similar to those shown in FIG. 21.

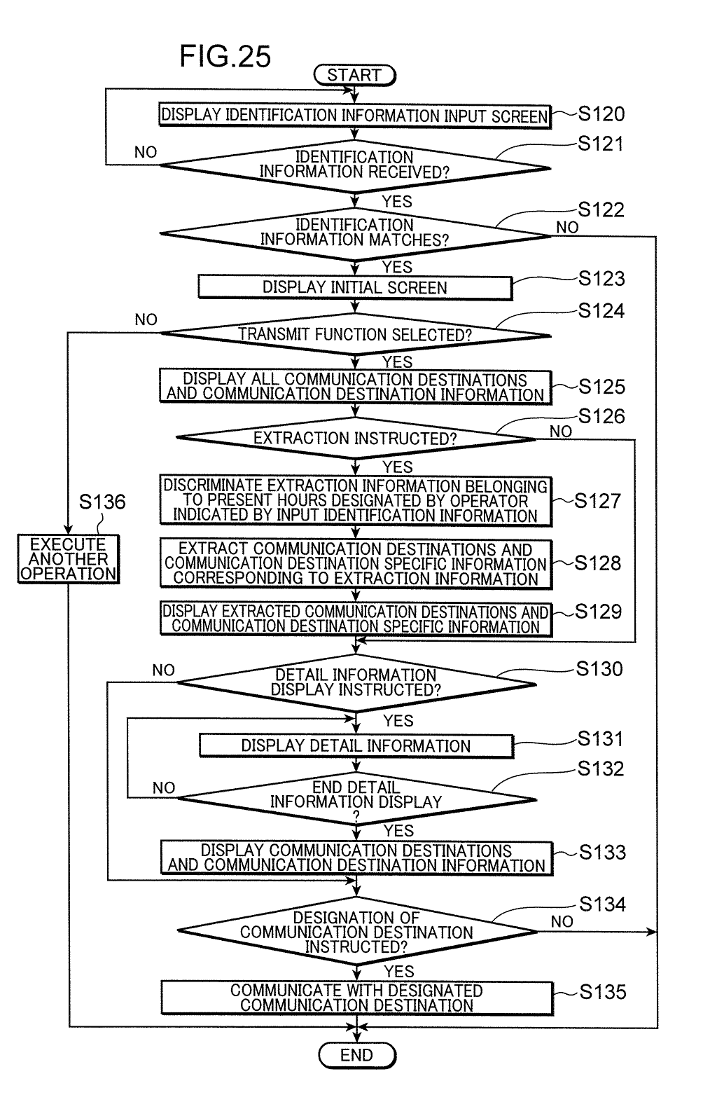

Next, there is described a second modification of the fifth embodiment of the process of displaying the communication destinations and communication destination information by the complex machine 1. FIG. 25 is a flow chart showing the second modification of the fifth embodiment of the process of displaying the communication destinations and communication destination information by the complex machine 1. Note that processings similar to those shown in FIGS. 21, 24 and other figures are not shown.

Also in this second modification, when the priority button 450 displayed on the address book screen C is pressed by an operator and an extraction instruction is received during the display of the address book screen C (e.g. FIG. 6) (YES in S126) after the receipt of identification information through the operation of the operator on a login screen E (e.g. FIG. 8) displayed by the display controller 522 (YES in S121, YES in S122) when the complex machine 1 is started, the display controller 522 discriminates the extraction information belonging to the present hours and stored in the extraction information storage 55 in correspondence with the identification information received in S122 (S127) and extracts all the pairs of communication destination and communication destination information in correspondence with the discriminated extraction information from the communication destination storage 53 (S128). The display controller 522 generates a new address book screen C3 as exemplarily shown in FIG. 23 using this extraction result and causes the display unit 410 to display the generated address book screen C3 (S129). Succeeding processings of S130 to S136 are similar to those shown in FIGS. 21 and 24.

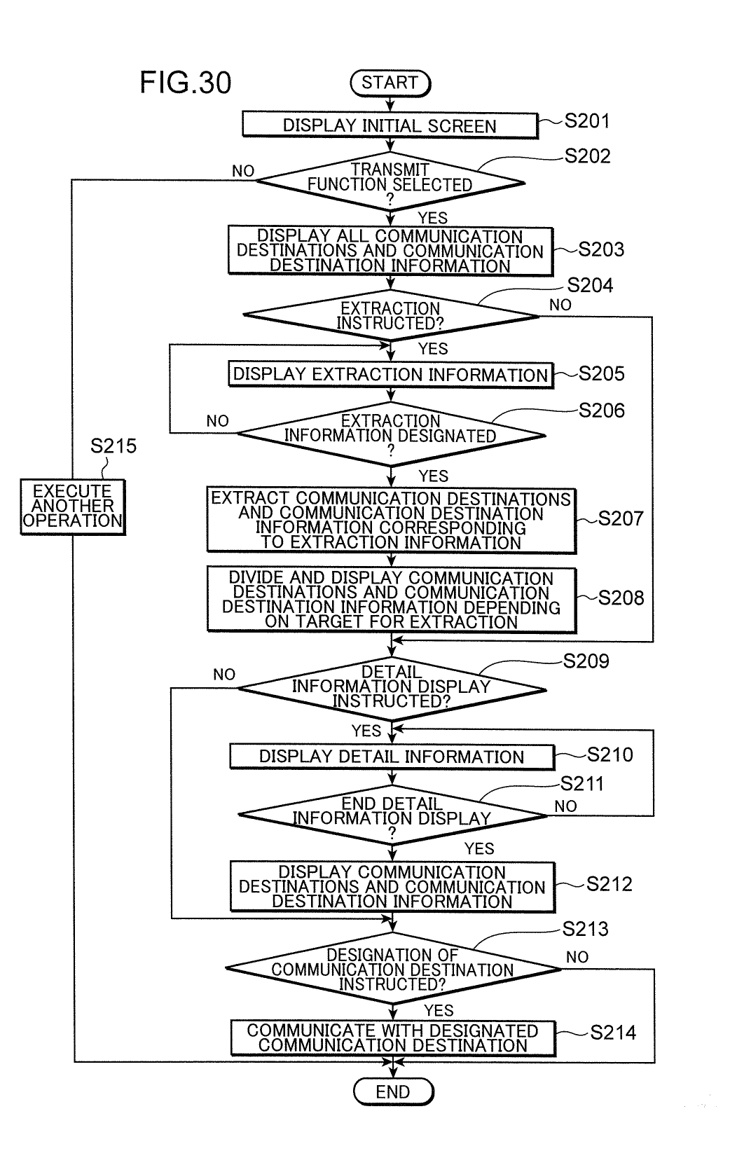

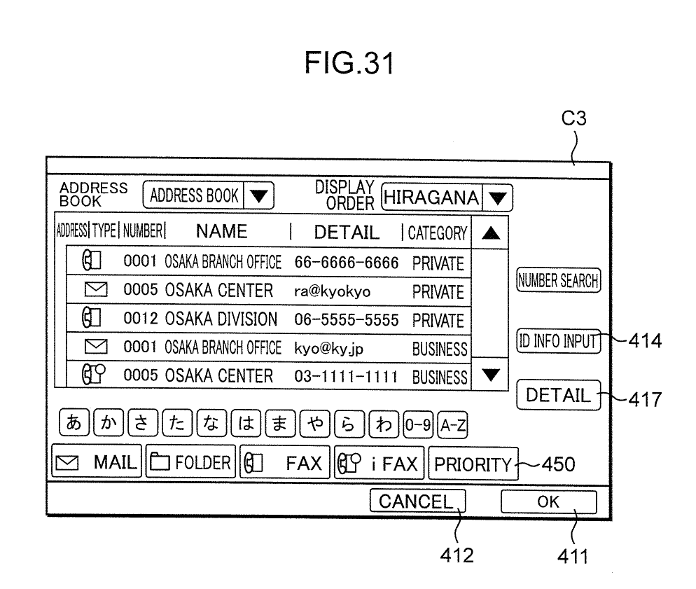

Next, there is described a third modification of the fifth embodiment of the process of displaying the communication destinations and communication destination information by the complex machine 1. FIG. 30 is a flow chart showing the third modification of the fifth embodiment of the process of displaying the communication destinations and communication destination information by the complex machine 1. Note that processings similar to those shown in FIGS. 21, 24, 25 and other figures are not shown. FIG. 31 is a diagram showing an exemplary display screen.

In this third modification, the display controller 522 extracts the communication destinations and communication destination information in correspondence with designated extraction information (S207) and the display controller 522 generates a new address book screen C3 which also displays the communication destinations and communication destination information that are not target for extraction according to the extraction information. At this time, the display controller 522 generates the new address book screen C3 on which the communication destinations and communication destination information extracted according to the extraction information and those that are not target for extraction are so divided that they are not displayed in a mixed order, for example, as shown in FIG. 31, and causes the display unit 410 to display this new address book screen C3 (S208). Note that FIG. 31 exemplarily shows a case where designation of the private extraction information is received by the display controller 522 and the display controller 522 extracts the respective communication destinations and communication destination information in correspondence with the designated private extraction information.

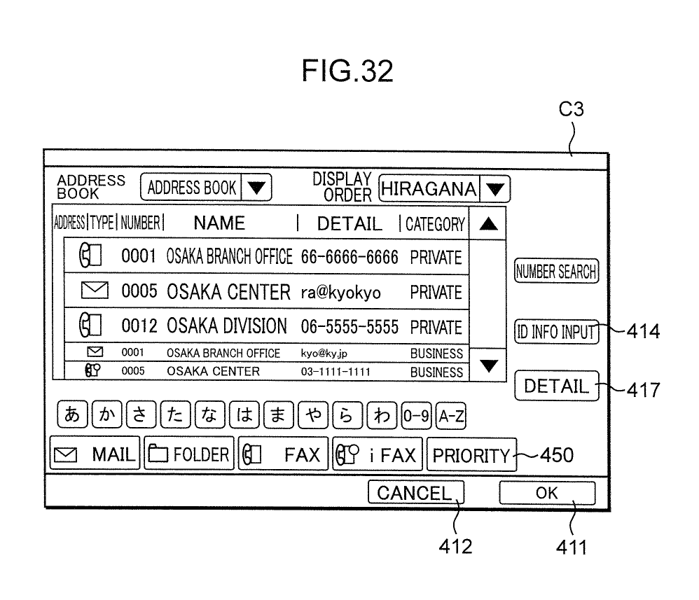

Alternatively, in the processing of S208, the display controller 522 may generate a new address book screen C3 on which the communication destinations and communication destination information are displayed in a different mode for each corresponding extraction information, for example, as shown in FIG. 32 after dividing the communication destinations and communication destination information extracted according to the extraction information and those that are not target for extraction, and cause the display unit 410 to display this new address book screen C3. Note that FIG. 32 exemplarily shows a case where designation of the private extraction information is received by the display controller 522 and the display controller 522 extracts the respective communication destinations and communication destination information in correspondence with the designated private extraction information.

According to the present embodiment, the display controller 522 causes the display unit 410 to further display communication destinations and pieces of communication destination information, which are not target for extraction, such that the extracted communication destinations and pieces of communication destination information and the communication destinations and pieces of communication destination information that are the target for extraction are displayed in different display modes. Thus, all the pieces of communication destination information can be confirmed regardless of whether or not the communication destination information is the target for extraction, and whether or not the communication destination information is the target for extraction can be easily recognized based on the different display modes.

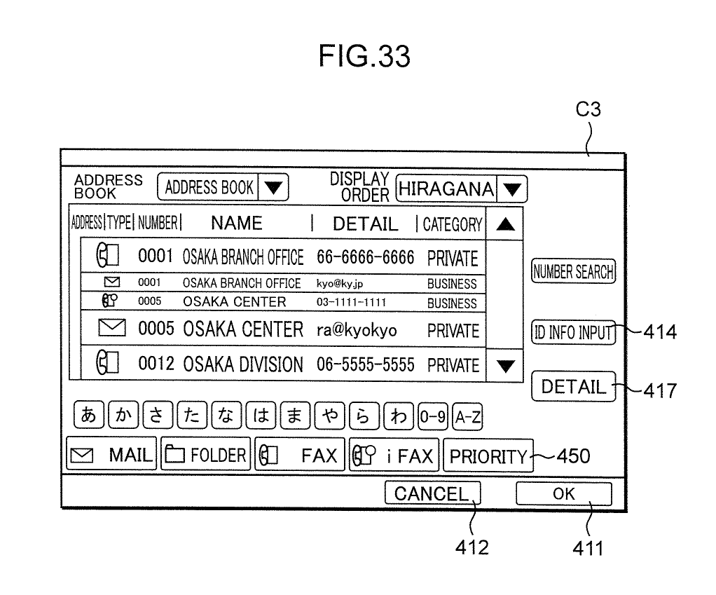

Although the display controller 522 divides and displays the communication destinations and communication destination information extracted according to the extraction information and those that are not target for extraction in the processing of S208, it may generate a new address book screen C3 on which the communication destinations and communication destination information are displayed in a different mode for each corresponding extraction information, for example, as shown in FIG. 32 without dividing them and cause the display unit 410 to display this new address book screen C3. Note that FIG. 33 exemplarily shows a case where designation of the private extraction information is received by the display controller 522 and the display controller 522 extracts the respective communication destinations and communication destination information in correspondence with the designated private extraction information.

In the display process of this third modification, the identification information receiving process similar to S105 and S106 for extracting the communication destinations and communication destination information corresponding to the extraction information belonging to the hours may be applied instead of the process of S205 to S207 in the third modification similar to the first modification shown in FIG. 24.

In the display process of this third modification, the communication destinations and communication destination information corresponding to the extraction information belonging to the hours designated by the operator and indicated by the input identification information may be extracted similar to the second modification shown in FIG. 25. In this case, the process of S120 to S128 in the second modification shown in FIG. 25 may be applied instead of the process of S201 to S207 in the third modification.

As a method for making the display modes different, the display controller 522 may employ a different method such as the one for making colors different or the one for making shapes such as fonts different in addition to the above method for making the display sizes different.

The present invention is not limited to the constructions of the above embodiments and various changes can be made. For example, although the extraction process by the display controller 522 is performed when the extraction instruction from the operator is received by the extraction instruction receiving section 524 in the process of displaying the communication destinations and communication destination information by the complex machine 1 in the complex machine 1 shown in the above respective embodiments and modifications, the display controller 522 may perform the extraction process without the extraction instruction receiving section 524 receiving any extraction instruction.

Further, although the identification information is input by the operator and related to the display priority and the extraction information in the process performed upon setting the display priority or extraction information of the communication destination information for the communication destination by the complex machine 1 in the complex machine 1 shown in the above respective embodiments and the display controller 522 carries out the extraction for each operator identified by the identification information in the process of displaying the communication destinations and communication destination information by the complex machine 1 in the complex machine 1 shown in the respective embodiments and modifications, the input of the identification information may not be received in the process performed upon setting the display priority or extraction information and the display controller 522 may not carry out the extraction for each operator indicated by the identification information in the above display process.

Further, although the display controller 522 reads the detail information stored in the communication destination storage 53 in correspondence with the communication destination and causes the display unit 410 to display this detail information, for example, on the detail information screen D2 when the detail information display instruction is received by the display controller 522 in the process of displaying the communication destinations and communication destination information by the complex machine 1 in the complex machine 1 shown in the respective embodiments and modifications, the detail information may not be displayed in this process of displaying the communication destinations and communication destination information.

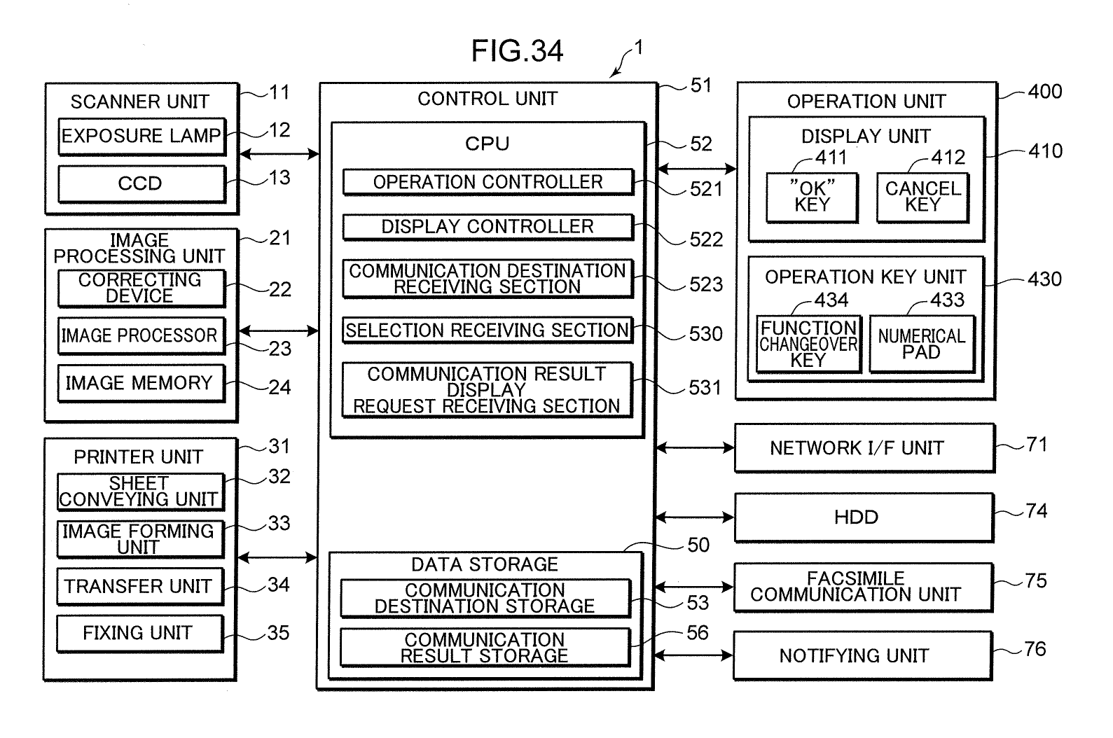

Next, there is described a sixth embodiment of the process of displaying the communication destinations and communication destination information by a complex machine 1. FIG. 34 is a control block diagram of the complex machine 1 for performing the process according to the sixth embodiment. Note that a construction similar to that shown in FIG. 3 is not described.

A CPU 52 of the complex machine 1 for performing the process according to the sixth embodiment includes a selection receiving section 530 and a communication result display request receiving section 531 in addition to an operation controller 521, a display controller 522 and a communication destination receiving section 523.

The selection receiving section 530 receives an instruction to allow an operator to select an arbitrary communication destination from communication destinations on an address book screen C displayed on the display unit 410 by the display controller 522 and stored in a communication destination storage 53 based on the operation of an operation unit 400 by the operator. Note that the display controller 522 does not cause the display unit 410 to display a communication result on the address book screen C for the communication destination selected as the communication destination is not to be displayed by the operator and received by the selection receiving section 530.

The communication result display request receiving section 531 receives a display request of a communication result corresponding to each communication destination displayed on the address book screen C by a display control of the display controller 522 from the operator. There are two embodiments according to the present invention: (1) first example in which, when causing the display unit 410 to display the address book screen C, the display controller 522 causes the display unit 410 to display a communication result stored in a communication result storage 56 in correspondence with each communication destination regardless of whether or not a communication result display request made by the operator is received by the communication result display request receiving section 531 (in this embodiment, the communication result display request receiving section 531 is not essential constituent element) and (2) second example in which, when causing the display unit 410 to display the address book screen C, the display controller 522 causes the display unit 410 to display a communication result on an initial screen of the address book screen C in the case of judging that the communication result corresponding to the communication destination stored in the communication result storage 56 indicates a communication error and causes the communication result to be displayed on the address book screen C in the case of receiving a display request from the operator by the communication result display request receiving section 531 even if the communication result does not indicate the communication error (in this embodiment, the communication result display request receiving section 531 is an essential constituent element). In the case of the second example, when causing the display unit 410 to initially display the address book screen C, the display controller 522 causes the display of the communication result together with the communication destination for which the communication result was judged to indicate the communication error upon judging that the communication result corresponding to the communication destination stored in the communication result storage 56 indicates the communication error while not causing the display of the communication result together with the communication destination for which the communication result was judged not to indicate the communication error.

Further, a data storage 50 includes the communication destination storage 53 and the communication result storage 56.

The communication result storage 56 is composed of a memory and the like and stores communication results for communications obtained by the operation controller 521 (e.g. communication error indicating that the communication was not established, communication success indicating that the communication was established, etc.) at the time of communication by the network I/F unit 71 and communication by the facsimile communication unit 75. The following types of communication errors are obtained as the communication results by the operation controller 521 and stored in the communication result storage 56: (1) in the case of electronic mail transmission, information to the effect that a transmission destination address was invalid and transmission could not be completed, (2) in the case of data transmission to a personal computer, information to the effect of access denial by the personal computer as a communication destination and (3) in the case of facsimile transmission, information to the effect of call rejection or busy line at the communication destination.

An image display device according to one embodiment of the present invention is provided with the operation unit 400, the display unit 410, the operation controller 521, the display controller 522 and the communication result storage 56 and, additionally, at least either one of the network I/F unit 71 and the facsimile communication unit 75.

A display control program according to one embodiment of the present invention is stored in a storage medium in the complex machine 1 such as the HDD 74 and the CPU 52 executes an operation control in accordance with the display control program to function as the display controller 522, the communication destination receiving section 523, the selection receiving section 530 and the communication result display request receiving section 531 and to cause the memory of the control unit 52 to function as the communication result storage 56. This display control program is stored in the HDD 74 or the like by being read from a CD-ROM or DVD or being downloaded from a server on Internet by the network I/F unit 71.

However, the display controller 522, the communication destination receiving section 523, the selection receiving section 530 and the communication result display request receiving section 531 are not necessarily realized by the operation control of the CPU 52 in accordance with the display control program. The display controller 522, the communication destination receiving section 523, the selection receiving section 530 and the communication result display request receiving section 531 may be provided as hardware in the form of circuits or the like.

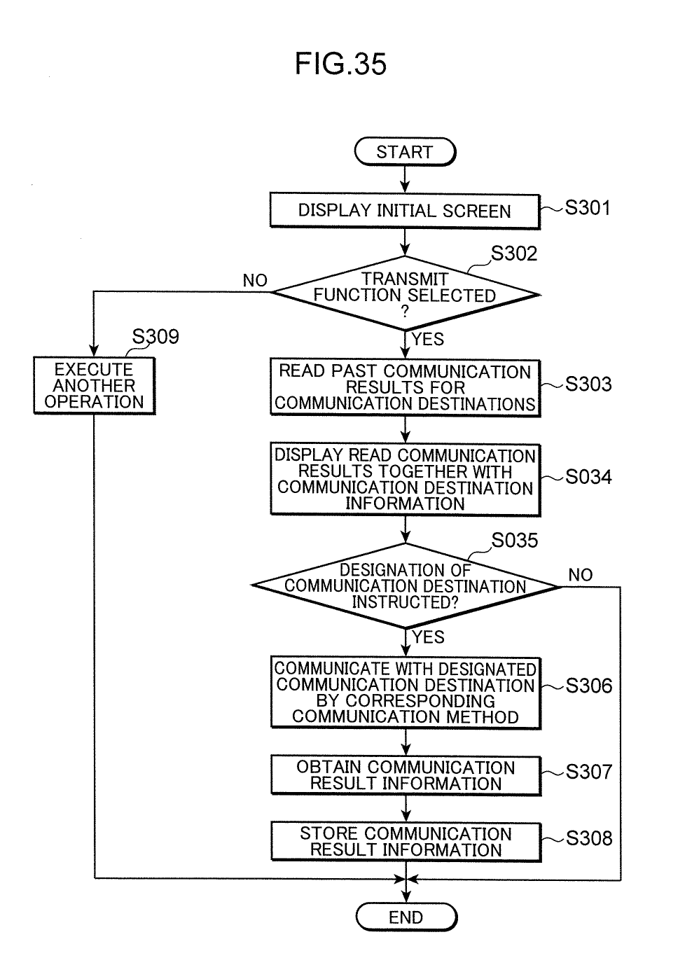

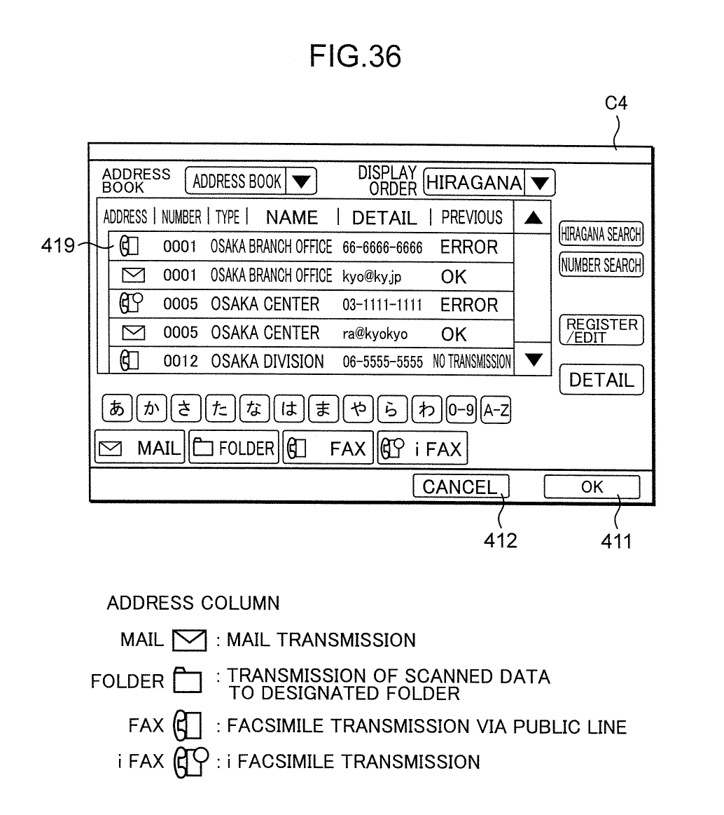

Next, there is described an first example of sixth embodiment of the process of displaying the communication destinations and communication destination information by the complex machine 1. FIG. 35 is a flow chart showing the first example of sixth embodiment of the process of displaying the communication destinations and communication destination information by the complex machine 1. FIG. 36 is a diagram showing an exemplary display screen of the display unit 410.

When the main power supply of the complex machine 1 is turned on by an operator, the display controller 522 causes the display unit 410 to display an initial screen A as shown in FIG. 5 (S301). In this embodiment, the display controller 522 shows an example of displaying a display screen, on which operation conditions of the copy function can be set, as an example of the initial screen A.

When an operation instruction other than those of the transmit function such as an instruction to execute a copying operation is input by the operator and received by the operation controller 521 while the display controller 522 is causing the display unit 410 to display the initial screen A (NO in S302), the input operation is executed by the operation controller 521 (S309).

When one of the function changeover keys 434, i.e. transmit key 434 of the operation key unit 430 is depressed by the operator and an instruction to start the transmit function for transmitting image data or the like obtained in the complex machine 1 to an external apparatus is received by the operation controller 521 based on this depressing operation while the display controller 522 is causing the display unit 410 to display the initial screen A (YES in S302), the display controller 522 reads the communication destinations (addresses indicating the communication destinations of the electronic mail transmission, addresses indicating personal computers and their folders in which document image data is to be stored, facsimile numbers, or the like) stored in the communication destination storage 53 and reads past communication results stored in correspondence with the read communication destinations (in this embodiment, it is assumed that the last communication result is stored for each communication destination in the communication result storage 56) from the communication result storage 56 (S303).

Subsequently, the display controller 522 reads image data and the like necessary to display an address book screen C for receiving designation of the communication destination from the operator from an unillustrated data storage, generates the address book screen C4 as exemplarily shown in FIG. 36 using the communication destinations read in S303 and the communication results corresponding to the respective communication destinations, and causes the display unit 410 to display the generated address book screen C4 (S304).

When a display part of the desired communication destination on the address book screen C4 is pressed by a touching operation of the operator during the display of the address book screen C4 on the display unit 410 by the display controller 522, the communication destination displayed in this pressed part and the communication method stored in the communication destination storage 53 in correspondence with the desired communication destination are received as the communication destination and communication method this time by the communication destination receiving section 523 (YES in S305).

When the OK button 411 on the address book screen C4 is pressed by a touching operation of the operator after the communication destination and communication method are received in S305, the operation controller 521 carries out communication with the received communication destination by the communication method (S306). For example, if the operator presses the OK button 411 after pressing a display part 419 “Name: Osaka Branch Office, Detail: 66-6666-6666” displayed as a facsimile transmission destination on the address book screen C4, facsimile communication is carried out to the facsimile number of “66-6666-6666” by the facsimile communication unit 75. In this case, the operation controller 521 causes the scanner unit 11 to read an image of a document set in the document reading unit 500 and causes the facsimile communication unit 75 to transmit the read document image to the designated communication destination number.

After the completion of the above communication, the operation controller 521 obtains information on this communication result (e.g. a communication error indicating failure to establish communication, a communication success indicating establishment of communication, etc. as described above) from the facsimile communication unit 75 or the network I/F unit 71 (S307). Further, the operation controller 521 causes the obtained information on the communication result to be stored in the communication result storage 56 (S308). The communication result stored in this way is used to display the address book screen C4 by the display controller 522 in S304 when the communication destination is designated at the time of the next communication.

In this first example, the last communication result is stored in the communication result storage 56 for each communication destination and the display controller 522 reads the last communication result of each communication destination from the communication result storage 56 and displays it on the address book screen C4. However, without being limited to this, a predetermined number (e.g. 20) of communication results up to the last communication may be stored for each communication destination and the display controller 522 reads the predetermined number of communication results of each communication destination from the communication result storage 56 and displays them on the address book screen C4.

According to the present embodiment, the display controller 522 reads communication results corresponding to the respective communication destinations from the communication result storage 56 together with the respective communication destinations and causes the communication results to be displayed when causing the display unit 410 to display a communication destination list screen. Thus, the operator can easily confirm the results of communications carried out in the past before communication with the communication destination.

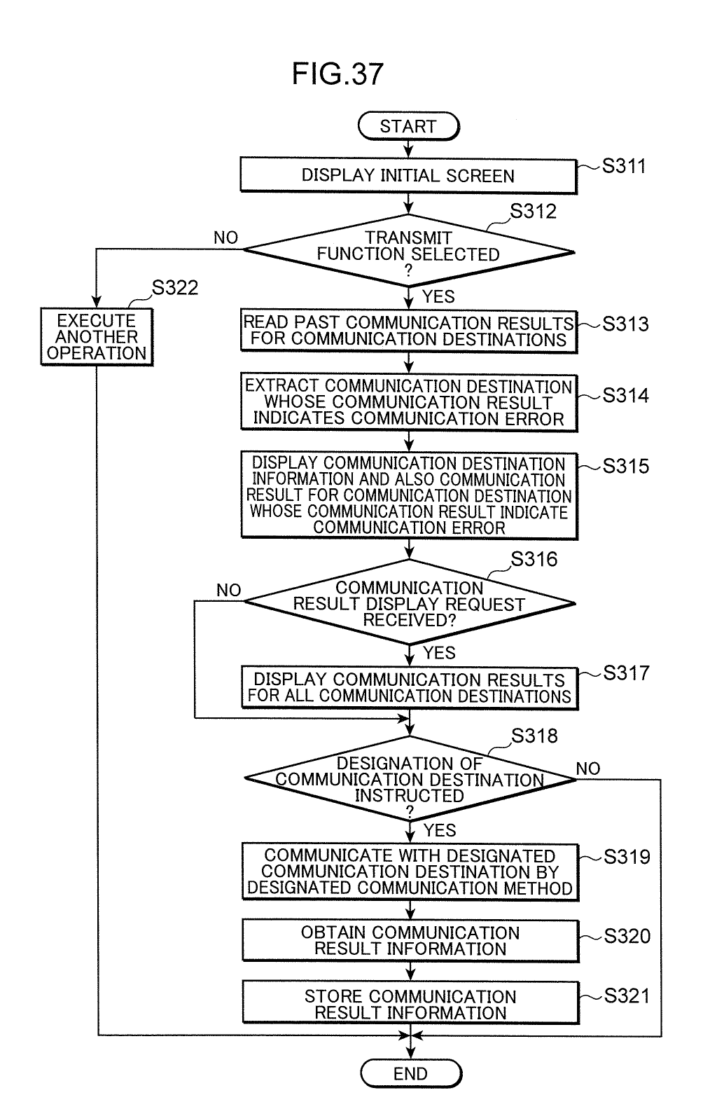

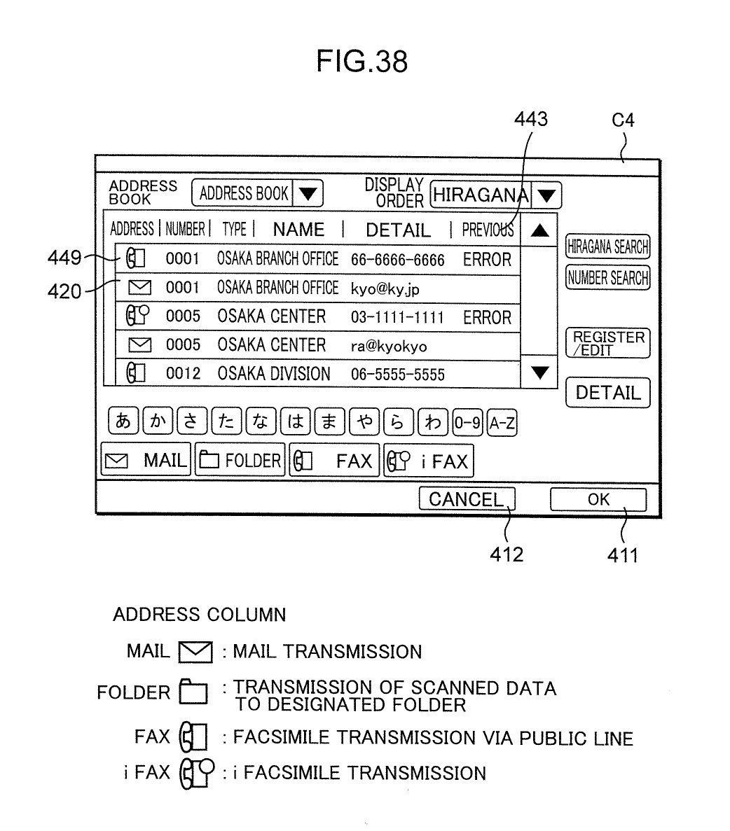

Next, there is described an second example of sixth embodiment of the process of displaying the communication destinations and communication destination information by the complex machine 1. FIG. 37 is a flow chart showing the second example of the sixth embodiment of the process of displaying the communication destinations and communication destination information by the complex machine 1. FIG. 38 is a diagram showing an exemplary display screen of the display unit 410. Note that processings similar to those of the embodiment shown in FIG. 35 are not described.

In this modification, when an instruction to start the transmit function is received by the operation controller 521 (YES in S312) and the display controller 522 reads the communication destinations stored in the communication destination storage 53 and the past communication results stored in correspondence with the read communication destinations from the communication result storage 56 (S313), the display controller 522 further extracts each communication destination the last communication result of which indicates a communication error (S314).

Based on the extraction result of S314, the display controller 522 displays the respective communication destinations and, only for each communication destination the last communication result of which indicates the communication error, displays the communication result (i.e. to the effect of the communication error) on the address book screen C4 as shown in FIG. 38 (S315). At this time, the display controller 522 displays no communication result on the address book screen C4 for each communication destination, the last communication result of which does not indicate the communication error, based on the extraction result of S314.

According to the present embodiment, the display controller 522 causes an initial screen of the communication destination list screen to display that there was a communication error in the communication with the communication destination when the communication result corresponding to the communication destination indicates a communication error and to display no communication result for the communication destination on the communication destination list screen when the communication result indicates no communication error. Thus, a situation can be avoided where it becomes more difficult for the operator to grasp important information because the display of the communication destination list screen is complicated, and the operator can accurately grasp the fact that there was an error in the last communication, which is important information at the time of communication.

When a communication result display request is received by the communication result display request receiving section 531 via the operation unit 400 based on the operation of an operator after the display of the address book screen C4 in S315 (YES in S316), the display controller 522 displays the communication results for all the communication destinations as exemplarily shown in FIG. 36 (S317). For example, if a “previous” display part 443 shown in FIG. 38 is pressed by the operator, an instruction for the communication result display request is input to the operation unit 400 by the touch panel function and the communication result display request is received by the communication result display request receiving section 531 via the operation unit 400.

According to the present embodiment, the display controller 522 causes the initial screen of the communication destination list screen to display that there was a communication error in the communication with the communication destination when the communication result corresponding to the communication destination indicates a communication error and causes the communication destination list screen to display the communication result for the communication destination in the case of a communication result display request from the operator when the communication result indicates no communication error. Thus, the operator can accurately grasp the fact that there was an error in the last communication, which is important information at the time of communication, and can also grasp other communication results displayed according to needs.

In this case, the display controller 522 may display the communication result only for the communication destination designated by the operator. For example, if a display part 420 “Name: Osaka Branch Office, Detail: kyo@ky.jp” displayed as an electronic mail communication destination on the address book screen C and then the OK button 411 are pressed by the operator for designation, the display controller 522 may display the communication result for this designated communication destination.

After the above processing, processings of S318 to S321 are performed also in this modification similar to those of S305 to S308 in the embodiment shown in FIG. 35.

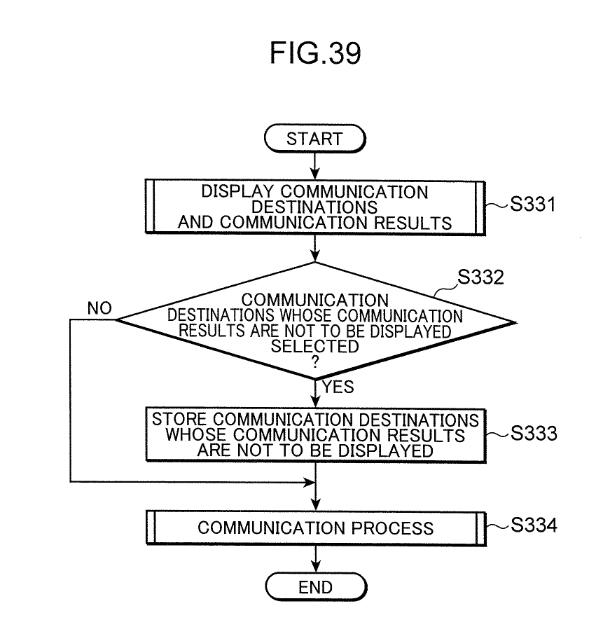

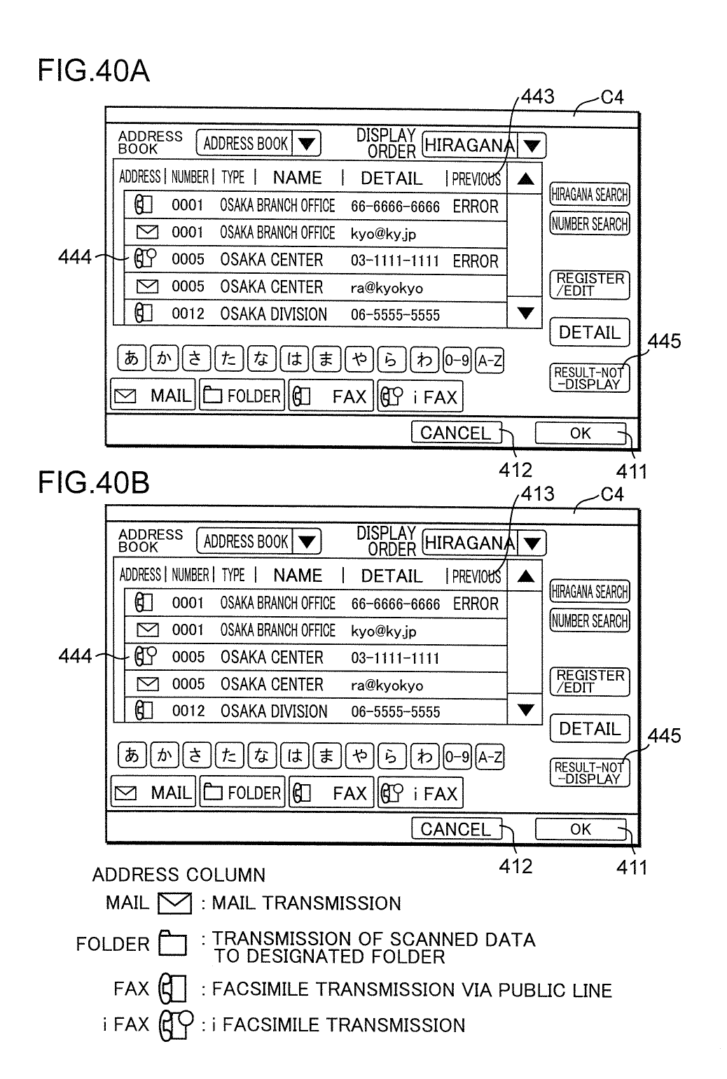

Next, there is described a further modification of the sixth embodiment and its modification. FIG. 39 is a flow chart showing this further modification. FIGS. 40A and 40B are diagrams showing exemplary display screens of the display unit 410. Note that processings similar to those of the sixth embodiment shown in FIG. 35 or the modification shown in FIG. 37 are not described.

In this further modification, the display controller 522 displays the communication result only for a specific communication destination selected by an operator.

In this modification, if a display part 444 of a desired communication destination on an address book screen C4 shown in FIG. 40A is, for example, pressed by a touching operation of the operator during the display of the address book screen C4 on the display unit 410 by the display controller 522 and then a “result-not-display” button 445 is pressed so that selection of the communication destination displayed in the pressed part is received by the selection receiving section 530 via the operation unit 400 by the touch panel function (YES in S332), the selection receiving section 530 stores this communication destination as the one for which the communication result is not to be displayed (S333). A succeeding processing (S334) is similarly performed as in the first example of the sixth embodiment shown in FIG. 35 or the second example of the sixth embodiment shown in FIG. 37.

In S331 of this further modification, when the instruction to start the transmit function is received by the operation controller 521 and the display controller 522 reads the communication destinations stored in the communication destination storage 53 and their corresponding communication results, the display controller 522 does not cause the communication result to be displayed on the address book screen C4 as exemplarily shown in FIG. 40B for each communication destination stored as the one for which the communication result is not to be displayed. At this time, the display controller 522 may not read the corresponding communication result for each communication destination stored as the one for which the communication result is not to be displayed.

By this, the communication result of the communication destination whose selection is received by the selection receiving section 530 is not displayed on the address book screen C4, wherefore the operator can allow the communication result only for the desired communication destination to be displayed on the address book screen C4, the display content of the address book screen C4 can look simple and can be narrowed down to the communication results desired by the operator, so that the operator can easily grasp the communication results.

The constructions and processes according to the embodiments shown in FIGS. 1 to 40 are merely examples of the constructions and processes of the display control device and the image forming apparatus according to the present invention and the construction and processes of the image forming apparatus according to the present invention are not limited to the contents described above.

Although the image forming apparatus according to the present invention is described as the complex machine 1 in the above respective embodiments, it is not limited to the complex machine and may be a copier, a facsimile machine, a printer or the like. Further, the present invention is not limited to image forming apparatuses and may be applied to other communication apparatuses such as mobile phones and mobile apparatuses capable of data communication.

This application is based on Japanese Patent application serial Nos. 2010-017764, 2010-031685 and 2010-031686 filed in Japan Patent Office on Jan. 29, 2010 and Feb. 16, 2010, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image display device, comprising:
a communication unit that carries out communication;
a communication destination storage capable of storing a plurality of pieces of communication destination information, each of which is a combination of a communication method and communication destination specific information used for this communication method, for each communication destination to be communicated with by the communication unit;
a display unit that displays the communication destinations and communication destination information;
a display controller that causes the display unit to display the communication destination information for each communication destination stored in the communication destination storage;
a communication destination receiving section that receives the communication destination, with which communication is carried out by the communication unit, together with the communication destination information from an operator when pieces of communication destination information for the communication destinations are displayed on the display unit by the display controller; and
a selection criterion storage that stores a selection criterion used to select the communication destinations and their corresponding pieces of communication destination information stored in the communication destination storage as items to be displayed on the display unit;
wherein the display controller extracts the communication destination and communication destination information from the communication destination storage according to the selection criterion stored in the selection criterion storage and causes the display unit to display the extracted communication destination information and communication destination specific information when causing the display unit to display the communication destinations and their corresponding pieces of communication destination information.

2. An image display device according to claim 1, wherein:
the selection criterion storage is a display priority storage that stores a display priority to the display unit by the display controller for the respective pieces of communication destination information of the communication destination as the selection criterion when a plurality of pieces of communication destination information are stored for one communication destination; and
the display controller extracts the communication destination information according to the display priority stored in the display priority storage for each communication destination including a plurality of pieces of communication destination information and causes the display unit to display the extracted information when causing the display unit to display the communication destination information for each communication destination.

3. An image display device according to claim 2, further comprising an extraction instruction receiving section that receives an extraction instruction to execute extraction by the display controller from the operator, wherein:
the display controller extracts the communication destination information with a high display priority for each communication destination including the plurality of communication destination information when the extraction instruction is received by the extraction instruction.

4. An image display device according to claim 2, further comprising a display priority receiving section that receives designation of the communication destination information to be displayed for the communication destination by the display controller from the operator as the display priority, wherein:
the display priority storage stores the designation of the communication destination information received by the display priority receiving section as the display priority; and
the display controller extracts the communication destination information with the display priority defined by the designation of the communication destination information as the communication destination information with a high display priority.

5. An image display device according to claim 4, further comprising an identification information receiving section that receives input of identification information for identifying each operator for each different operator, wherein:
the display priority storage stores the designation of the communication destination information received by the display priority receiving section and the identification information corresponding to the communication destination information as the display priority; and
the display controller extracts the communication destination information assumed to have a high display priority for each piece of identification information.

6. An image display device according to claim 2, further comprising a use frequency detecting section that detects a use frequency, at which each communication destination information was used for communication by the communication unit, for each communication destination, wherein:
the display controller extracts the communication destination information with a high display priority for each communication destination including the plurality of communication destination information using the use frequency detected by the use frequency detecting section as the display priority.

7. An image display device according to claim 2, further comprising a latest destination information detecting section that detects the communication destination information most recently used for communication by the communication unit for each communication destination, wherein:
the display controller extracts the communication destination information with a high display priority for each communication destination including the plurality of communication destination information using a detection result by the latest destination information detecting section as the display priority.

8. An image display device according to claim 2, further comprising a latest storage information detecting section that detects the communication destination information most recently stored in the communication destination storage for each communication destination, wherein:
the display controller extracts the communication destination information with a high display priority for each communication destination including the plurality of communication destination information using a detection result by the latest storage information detecting section as the display priority.

9. An image display device according to claim 6, further comprising an identification information receiving section that receives input of identification information for identifying each operator for each different operator, wherein:
the display priority storage stores the display priority indicated by the detection result for the communication destination information for each piece of identification information received by the identification information receiving section; and
the display controller extracts the communication destination information assumed to have a high display priority for each piece of identification information.

10. An image display device according to claim 2, wherein:
the display controller extracts the pieces of communication destination information according to the display priority stored in the display priority storage for each communication destination including the plurality of communication destination information and causes the display unit to display the extracted pieces of communication destination information in an order of the display priority when causing the display unit to display the pieces of communication destination information for each communication destination.

11. An image display device according to claim 10, wherein:
the display controller causes the display unit to display the extracted pieces of communication destination information in different display modes in the order of the display priority.

12. An image display device according to claim 2, wherein the display controller causes the display unit to further display the pieces of communication destination information that are not target for extraction, such that the extracted pieces of communication destination information and those that are not target for extraction are displayed in different modes.

13. An image display device according to claim 2, wherein:
the communication destination storage stores detail information belonging to the communication destination information together with the communication destination information;
the image display device further comprises a detail information display instruction receiving section that receives a detail information display instruction for the display of the detail information for each communication destination displayed on the display unit from the operator; and
the display controller reads the detail information of the communication destination information, for which the detail information display instruction was received by the detail information display instruction receiving section, from the communication destination storage and causes the display unit to display the read detail information.

14. An image display device according to claim 1, wherein:
the selection criterion storage is an extraction information storage that stores extraction information used to extract items to be displayed on the display unit by the display controller from the communication destinations and communication destination information used for these stored in the communication destination storage as the selection criterion in correspondence with the communication destinations and communication destination information used for these;
the image display device further comprises an extraction information receiving section that receives designation of the extraction information used for the extraction by the display controller out of pieces of extraction information stored in the extraction information storage from the operator; and
the display controller extracts the communication destinations and communication destination information used for these in correspondence with the extraction information received by the extraction information receiving section from the communication destination storage and causes the display unit to display the extracted communication destinations and communication destination information when causing the display unit to display the respective communication destinations and communication destination information used for these.

15. An image display device according to claim 14, further comprising an extraction instruction receiving section that receives an extraction instruction to execute extraction by the display controller from the operator, wherein:
the display controller extracts the communication destinations and communication destination information used for these in correspondence with the extraction information received by the extraction information receiving section and causes the display unit to display the extracted communication destinations and communication destination information when the extraction instruction is received by the extraction instruction receiving section.

16. An image display device according to claim 14, wherein:
the extraction information storage stores the extraction information according to hours; and
the display controller reads the extraction information corresponding to hours for the extraction from the extraction information storage, extracts the communication destinations and communication destination information used for these corresponding to the read extraction information and causes the display unit to display the extracted communication destinations and communication destination information.

17. An image display device according to claim 14, wherein:
the display controller extracts the communication destinations and communication destination information used for these corresponding to the extraction information received by the extraction information receiving section from the communication destination storage, and causes the display unit to further display the communication destinations and communication destination information that are not target for the extraction when the extracted communication destinations and communication destination information used for these are displayed on the display unit, such that the extracted communication destinations and communication destination information used for these and the communication destinations and communication destination information that are not target for the extraction are respectively displayed in different modes.

18. An image display device, comprising:
a communication unit that carries out communication;
a communication destination storage that stores communication destinations to be communicated with by the communication unit;
a display unit that displays the communication destinations;
a display controller that causes the display unit to display a communication destination list screen listing the communication destinations as candidate communication destinations;
a communication destination receiving section that receives the communication destination, with which communication is to be carried out by the communication unit, when the communication destination list screen is displayed on the display unit by the display controller; and
a communication result storage that stores at least a communication result on communication most recently carried out with the communication destination by the communication unit; and
wherein the display controller reads the communication results corresponding to the respective communication destinations from the communication result storage together with the respective communication destinations, and causes the read communication destinations and communication results on the communication destination list screen when the communication destination list screen is displayed on the display unit.

19. An image display device according to claim 18, wherein:
the display controller causes the communication result to be displayed on an initial screen of the communication destination list screen together with the communication destination when the last communication result stored in the communication result storage is judged to indicate a communication error and causes the communication result corresponding to the communication destination not to be displayed on the communication destination list screen for each communication destination whose communication result indicates no communication error when the communication destination list is displayed on the display unit.

20. An image display device according to claim 19, further comprising a communication result display request receiving section that receives a display request of the communication result corresponding to each communication result from the operator, wherein:
the display controller causes the communication result to be displayed on the initial screen of the communication destination list screen together with the communication destination when the last communication result stored in the communication result storage is judged to indicate a communication error and causes the communication result corresponding to the communication destination to be displayed on the communication destination list screen for each communication destination whose communication result indicates no communication error if the display request is received by the communication result display request receiving section when the communication destination list is displayed on the display unit.
